(19) United States
(12) Patent Application Publication
(10) Pub. No.: US 2002/0146494 A1
(43) Pub. Date: Oct. 10, 2002

(54) Apparatus and method for preparing food product

(76) Inventors: Peter J. Wilk, New York, NY (US); Joshua Weisberger, Englewood, NJ (US)

Correspondence Address: R. Neil Sudol, Coleman Sudol Sapone, P.C., 714 Colorado Avenue, Bridgeport, CT, 06605-1601, US

(21) Appl. No.: 09/908,303

(22) Filed: Jul. 18, 2001

Related U.S. Application Data
(63) Continuation-in-part of application No. PCT/US00/05569, filed on Mar. 3, 2000.
Application No. PCT/US00/05569 is a continuation of application No. 09/263,319, filed on Mar. 5, 1999, now Pat. No. 6,165,527.
(60) Provisional application No. 60/140,765, filed on Jun. 24, 1999.

(51) Int. Cl. A23G 1/00

(52) U.S. Cl. 426/279

(57) ABSTRACT

A machine for making a food product includes a cooking apparatus for cooking an aliquot of dough disposed in an elongate straight shape about a straight cooking member made of a material which has a chemical composition essentially impervious to cooking temperatures. The machine also incorporates a mechanism for extracting the cooking member from the cooked dough, thereby creating a chamber in the cooked dough. This mechanism has a contact member which is disposable in engagement with an end of the cooking member, a holder disposable in contact with the cooked dough for restraining the cooked dough, and a motive component operatively connected to at least one of the holder and the contact member for moving the one of the holder and the gripper relative to the other to remove the cooking member from cooked dough.

### BACKGROUND OF THE INVENTION

This invention relates to a machine and to an associated method for preparing a finished food product. More particularly, this invention relates to a machine and to an associated method for cooking and filling discrete food articles such as bagels.

The tastiest parts of certain baked food products such as muffins and bagels are those which are browned owing to exposure to an oven's convection currents. In eating muffins, people frequently separate the crowns from the bodies of the muffins in order to savor the enhanced flavor of the crowns. Likewise, in eating bagels, some people characteristically remove the inner, doughy parts of the bagel and eat only the shell, either alone or with filling such as a cream cheese and scallion spread or a salmon spread. Where a bagel is used to make a sandwich type food item, the hollowing out of the bagel provides the additional advantage of reducing the amount of filling that is squeezed out from between the bagel halves when the consumer bites into the bagel. Concomitantly, a hollow bagel is able to accommodate a greater amount of filling material.

A problem with the conventional manual method of removing dough from the interior of a bagel is inconvenience to the consumer. Another problem is waste that occurs when the removed interior dough is discarded rather than eaten.

Although certain food products such as doughnuts are frequently made with hollow interiors, into which a cream or fruit filling may be deposited, the method by which that hollow interior is formed is not applicable to bagels. Doughnuts can be made from a dough which separates during deep frying to produce an interior chamber. Bagels are cooked by an initial boiling step and a subsequent baking step. Bagels with hollow interiors will not naturally form during the two-step cooking process.

U.S. Pat. No. 5,807,599 describes a method for making a food product which utilizes an aliquot of dough disposed in a predetermined shape about a cooking member made of a material which has a chemical composition essentially impervious to cooking temperatures. The dough is cooked, e.g., boiled or baked, at a predetermined temperature for a predetermined period. The cooking member is maintained in the dough during the cooking thereof. After the cooking of the dough at the predetermined temperature for the predetermined period, the cooking member is removed from the cooked dough, thereby creating a chamber in the cooked dough.

Generally, as described in U.S. Pat. No. 5,807,599, the dough is molded about the cooking member to form the predetermined dough shape about the cooking member. Alternatively, the cooking member may be inserted or pressed into a lump of the dough.

According to U.S. Pat. No. 5,807,599, the cooking member is an elongate member made of a flexible material such as silicone. In that case, the elongate member may be bent to assume a desired form such as a circle. The dough generally conforms to the bent cooking member. The dough has a toroidal shape when the cooking member is bent into a circle.

As disclosed in U.S. Pat. No. 5,807,599, an end of the elongate member is left protruding from the uncooked dough form. After the dough is cooked, the elongate member is removed from the dough by grasping the protruding end of the elongate member and pulling the elongate member from the cooked dough. An edible filling may be injected or otherwise deposited into the chamber of the hollow dough cooked product after the removal of the elongate member.

### OBJECTS OF THE INVENTION

An object of the present invention is to provide a method for producing a cooked food product having an internal chamber for receiving an edible composition.

Another object of the present invention is to provide a machine for cooking or baking a food product so that the food product has a hollow interior for receiving an edible composition.

It is an additional object of the present invention to provide such a machine which is suitable for producing a straight elongate hollow bagel product.

A further object of the present invention is to provide a machine which produces such a food product having a filling.

A further object of the present invention is to provide a method of manufacturing a food product which is provided with a filling.

These and other objects of the present invention will be apparent from the descriptions and illustrations herein. Each embodiment of a machine or method disclosed herein is believed to meet one or more objects of the invention. No embodiment, however, need meet every object of the invention.

### SUMMARY OF THE INVENTION

A machine for making a food product comprises, in accordance with the present invention, cooking apparatus for cooking an aliquot of dough having at least one internal chamber formed by disposing the dough in an elongate shape about an elongate straight cooking member made of a material which has a chemical composition essentially impervious to cooking temperatures. The machine further comprises a mechanism for removing the cooking member from the dough, thereby opening the chamber. The mechanism includes a contact member disposable in engagement with an end of the cooking member, a holder disposable in contact with the dough for restraining the cooked dough, and a motive component operatively connected to at least one of the holder and the contact member for moving the one of the holder and the contact member relative to the other to remove the cooking member from the cooked dough.

The cooking apparatus preferably includes a baking oven. The cooking apparatus may include a molding component for shaping the dough about the cooking member to form the elongate shape about the cooking member. Alternatively, the cooking apparatus may include an extrusion device for extruding the dough about the cooking member. In the former case, the machine may be configured to position the cooking member in a mold cavity for forming the elongate shape substantially as a cylinder, so that the cooking member is disposed essentially along an axis of the cylinder.

The cooking member may include or take the form of an elongate substantially straight member made of substantially rigid material.

Pursuant to additional features of the present invention, the mechanism includes parts for removing multiple straight cooking members from multiple substantially straight elongate pieces of cooked dough simultaneously to thereby create a chamber in each of the elongate pieces of cooked dough, while the machine further comprises an injector for depositing an edible filling into the chamber after the pulling of the elongate cooking member from the cooked dough.

A method for making a food product comprises, in accordance with the present invention, cooking an aliquot of dough having an internal chamber formed by disposing the dough in an elongate shape about a straight cooking member made of a material which has a chemical composition essentially impervious to cooking temperatures. The method also comprises actuating a mechanical contact member to engage an end of the cooking member, operating a holder mechanism to contact the dough and restrain the dough, and activating a motive component operatively connected to at least one of the holder and the contact member to move the one of the holder and the contact member relative to the other to remove the cooking member from cooked dough.

The cooking of the dough includes baking the dough. Where the dough is to be processed into a bagel-type product, the cooking may also include boiling the dough. In that case, the boiling of the dough precedes the baking of the dough.

Pursuant to another feature of the present invention, the method additionally includes molding the dough about the cooking member to form the elongate shape about the cooking member prior to the cooking of the dough. The molding of the dough may be implemented in part by positioning the cooking member in a mold cavity for forming the elongate shape, so that the cooking member is disposed essentially along an axis of the cylinder.

In accordance with a further feature of the present invention, an edible filling is injected into the chamber after the pulling of the elongate cooking member from the cooked dough.

The present invention contemplates that multiple dough products are formed simultaneously. More particularly, multiple straight cooking members are removed from multiple substantially straight elongate pieces of cooked dough simultaneously to thereby create an elongate chamber in each of the elongate pieces of cooked dough.

A method for making a food product comprises, in accordance with a particular embodiment of the present invention, extruding an aliquot of dough in an elongate shape about a straight cooking member or insert, cooking the extruded dough at a relatively elevated temperature for a predetermined period to form a cooked food product having an internal chamber having essentially the predetermined configuration, and maintaining the cooking member in the dough during the cooking of the dough.

In accordance with a particular feature of the present invention, the cooking member is made of a material which disintegrates at cooking temperatures so that the cooking member essentially disappears by the end of a cooking operation. This embodiment of the method then additionally comprises gradually disintegrating the cooking member during the cooking of the dough so that, after the cooking of the dough at the elevated temperature for the predetermined period, the cooking member has disappeared from the cooked dough, thereby creating the chamber in the cooked dough. Wherein the cooking member is made of a material dissolvable in water, the disintegrating of the cooking member included dissolving the cooking member.

In an alternative approach, the cooking member is made of an edible composition, the method further comprising maintaining the edible composition in the chamber after the cooking of the dough to thereby form a composite food product having a filling surrounded by cooked dough. In that case, the providing of the aliquot of dough disposed in the predetermined shape about the cooking member or insert further includes hardening the shaped edible composition of the cooking member prior to molding of the dough about the cooking member. The hardening of the shaped edible composition may be accomplished by lowering the temperature of the shaped edible composition.

A method for preparing food comprises, in accordance with the present invention, (a) simultaneously forming dough about a plurality of elongate straight cooking members to form a plurality of substantially straight elongate dough preforms, (b) baking the dough preforms simultaneously while maintaining the elongate straight cooking members therein, (c) after cooking of the dough preforms, removing the cooking members from the respective cooked dough preforms, thereby producing a plurality of elongate straight cooked dough forms having elongate straight chambers, and (d) after the removing of the cooking members, automatically injecting edible filling material into the chambers of the cooked dough forms.

The forming of the dough about the cooking members preferably includes operating a machine to simultaneously form the dough about the cooking members. The removing of the cooking members preferably includes operating another machine to remove the cooking members from the respective cooked dough preforms. The removing of the cooking members is optionally effectuated substantially simultaneously. Also, the injecting of the edible filling may include simultaneously injecting the edible filling into the chambers.

### BRIEF DESCRIPTION OF THE DRAWING

FIG. 1 is a diagram of successive steps in a method for making a hollow bagel.

FIG. 2 is a schematic side elevational view of an automated assembly-line-type machine for forming a bagel preform which is cooked in boiling and baking steps illustrated in FIG. 1.

FIG. 3 is a schematic partial top plan view of a conveyor shown in FIG. 2.

FIG. 4 is a schematic side elevational view of an automated assembly-line-type machine for automatically removing an arcuate flexible insert or cooking member from a cooked bagel.

FIG. 5 is a diagram of a partial series of successive steps in an alternative method for making a hollow bagel.

FIG. 6 is a diagram of two series of steps for making a hollow bagel preform.

FIG. 7 is a diagram of another, alternate, series of successive steps for making a hollow bagel preform.

FIG. 8 is a diagram of yet another alternate series of steps for making a hollow bagel preform.

FIG. 9 is a schematic exploded perspective view of a cooking member and a straightening rod utilizable in performing the method of FIG. 6.

FIG. 10 is a schematic perspective view showing the rod of FIG. 9 inserted into the cooking member of that figure.

FIG. 11 is a diagram of selected successive steps in another method for producing a bagel preform.

FIG. 12 is a diagram of selected successive steps in an alternative method for producing a bagel preform.

FIG. 13 is a diagram of selected successive steps in another alternative method for producing a bagel preform.

FIG. 14 is a diagram of selected successive steps in an additional alternative method for producing a bagel preform.

FIG. 15 is a diagram of selected successive steps in a further alternative method for producing a bagel preform.

FIG. 16 is a diagram of selected successive steps in yet another alternative method for producing a bagel preform.

FIG. 17 is a schematic perspective view of a holder for retaining a slug of dough during insertion of a cooking member, showing the hold in a closed configuration.

FIG. 18 is a schematic perspective view of the holder of FIG. 17, showing the holder in an opened configuration for deposition and removal of a slug of dough.

FIG. 19 is a schematic perspective view of another holder, similar to the holder of FIGS. 17 and 18, showing the holder in an opened configuration for deposition and removal of a slug of dough.

FIG. 20 is a diagram of successive steps in a method for making a bagel with a filled center.

FIG. 21 is a schematic side perspective view of an assembly for filling a hollow food product, showing the assembly in a disassembled state.

FIG. 22 is a view similar to FIG. 6, showing the filling assembly of that drawing figure in an assembled and loaded state.

FIG. 23 is a view similar to FIG. 22, showing the filling assembly of that drawing figure in a filling discharged state.

FIG. 24 is a schematic side perspective view of the assembled and loaded filling assembly of FIG. 23, showing the injection of a filling into a hollow bagel.

FIG. 25 is a schematic side perspective view of a modified filling injection assembly.

FIG. 26 is a schematic side perspective view of a modified tubular filling member.

FIG. 27 is a pair of side perspective views of a flexible resilient plunger member showing that member in a straight and a flexed configuration for use with the tubular member of FIG. 26.

FIG. 28 is a schematic perspective view of a kit of filling assemblies shown singularly in FIG. 21.

FIG. 29 is a schematic perspective view of a kit of assembled filling assemblies.

FIG. 30 is a exploded perspective view of a tubular member and an associated handle of another filling assembly.

FIG. 31 is a schematic perspective view of the tubular member and handle of FIG. 30 coupled to one another.

FIG. 32 is a schematic perspective view of the tubular member and handle of FIG. 31, showing a step in the use of that assembly in a process for filling a bagel with a chamber.

FIG. 33 is a exploded perspective view of a tubular member and an associated handle of yet another filling assembly.

FIG. 34 is a schematic perspective view of the tubular member and handle of FIG. 33 coupled to one another.

FIG. 35 is a diagram of successive steps in a method for making a bagel with a hollowed center.

FIG. 36 is a schematic perspective view of a support plate for forming a doughy bagel preform surrounding a cooking insert.

FIG. 37 is partially a schematic perspective view and partially a block diagram of a device for forming doughy bagel preform surrounding a cooking insert.

FIGS. 38A through 38F are schematic cross-sectional views of a support plate or platform, dough sections and selected parts of the device of FIG. 37, showing successive steps in the production of a doughy bagel preform using the device of FIG. 37.

FIG. 39 is a schematic perspective view, partially broken away, of a manually operated bagel filling machine.

FIG. 40 is a schematic perspective view of another manually operated bagel filling machine.

FIG. 41 is partially a schematic side elevational view and partially a block diagram of an apparatus for removing a straight cooking member from a cooked elongate food product.

FIG. 42 is a schematic top view of an apparatus for removing straight cooking members or inserts from multiple cooked elongate food products.

FIG. 43 is a partial cross-sectional view taken along line XLIII-XLIII in FIG. 42.

FIG. 44 is a partial elevational view taken along line XLIV-XLIV in FIG. 43.

FIG. 45 is partially a schematic top plan view and partially a block diagram of an apparatus for producing cooked elongate food products in accordance with the invention.

### DESCRIPTION OF THE PREFERRED EMBODIMENTS

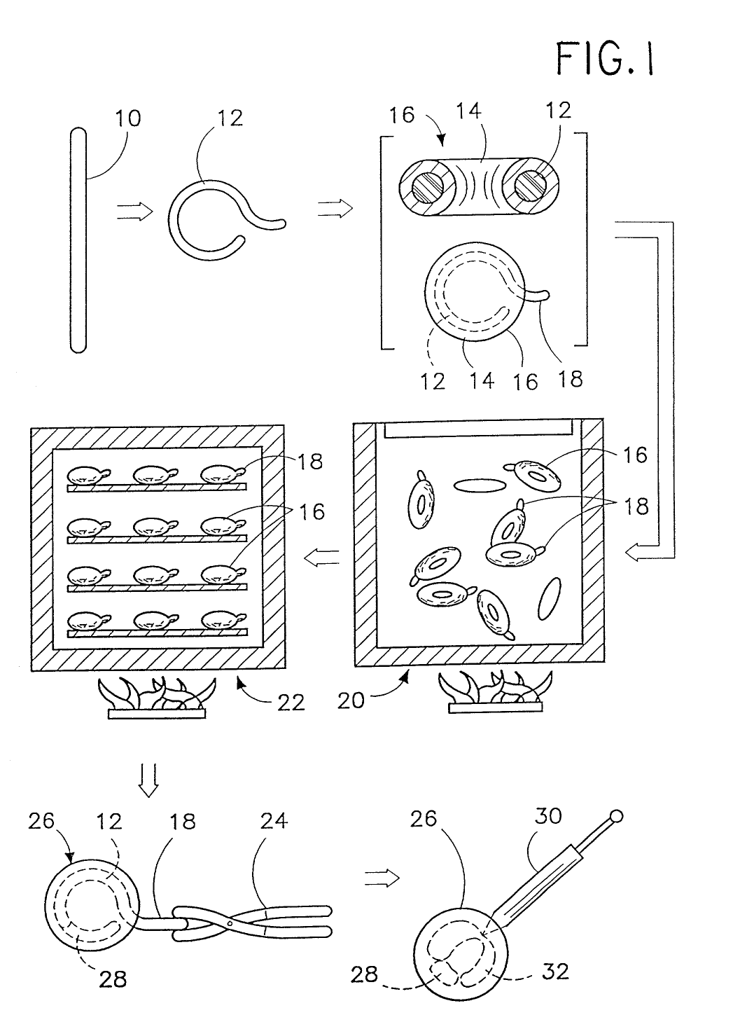

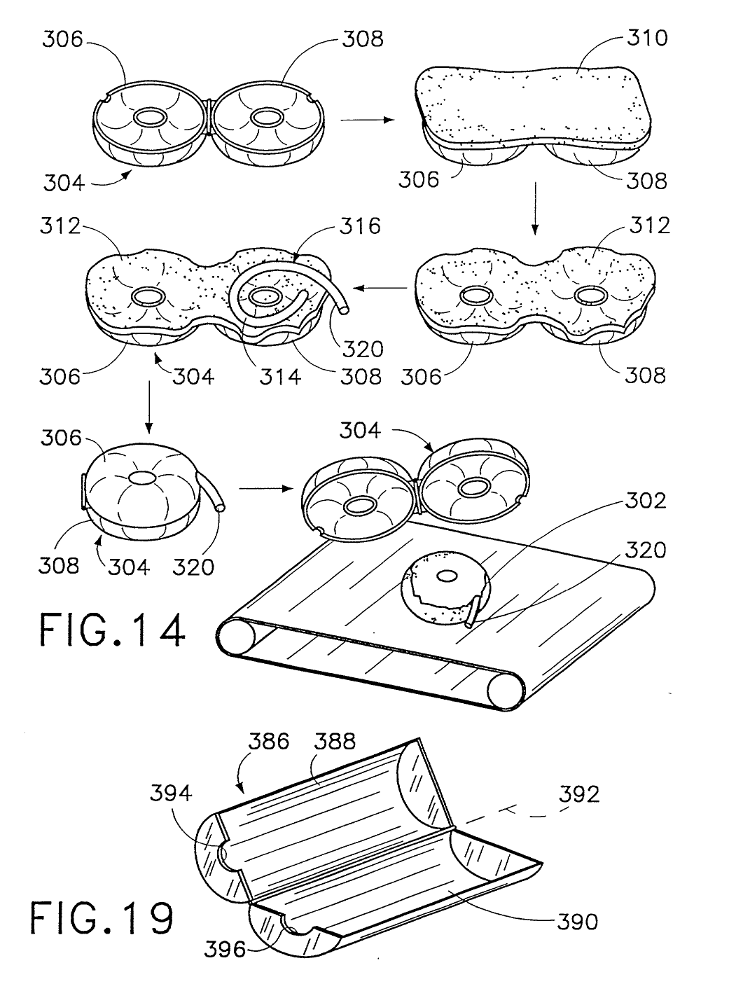

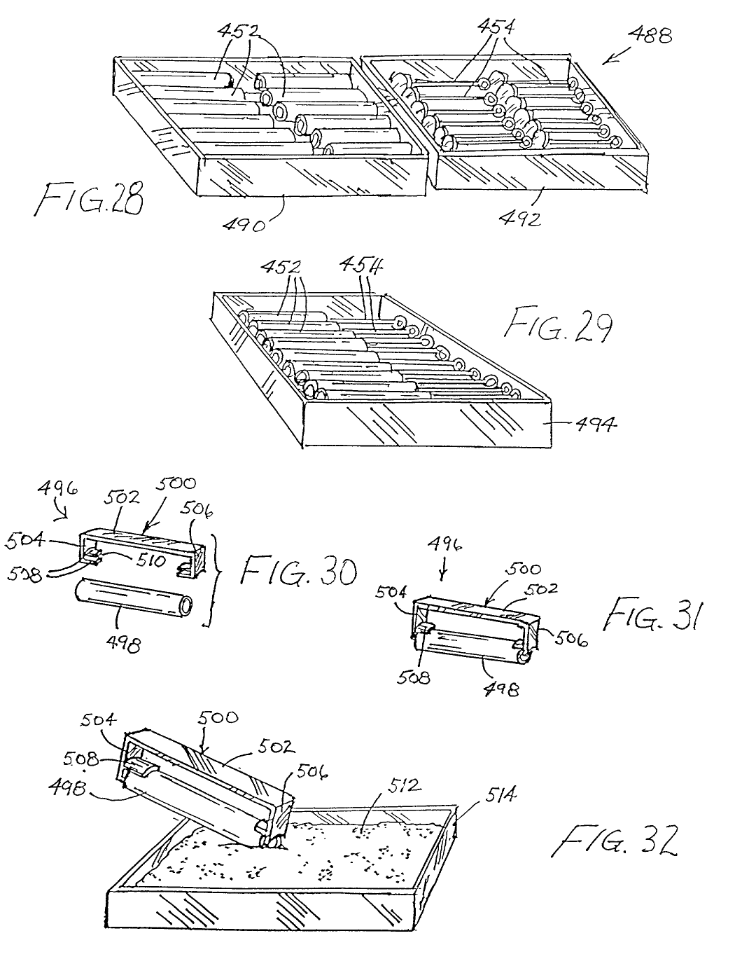

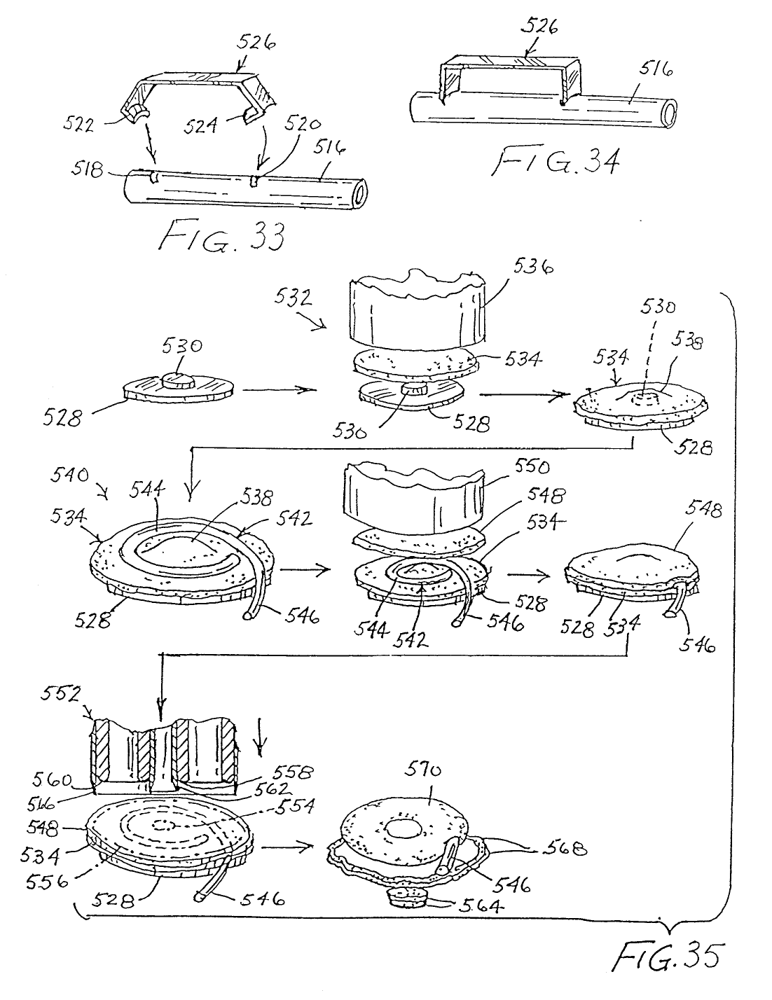

FIGS. 1 through 20 are basically directed to methods and apparatus useful in the manufacture of toroidal farinaceous products having arcuate or ring-shaped chambers for receiving comestible filling material. Some of the methods and apparatus of FIGS. 1 through 20 are also useful in the manufacture of elongate, generally cylindrical food products having straight or linear chambers for receiving an edible filling material. FIGS. 21 through 34 are directed to methods and apparatus for depositing comestible filling materials into hollow farinaceous products. FIGS. 35 through 40 are directed to additional methods and apparatus for manufacturing toroidal farinaceous products having arcuate or ring-shaped chambers for receiving comestible filling material.

As illustrated in FIG. 1, an elongate cooking member 10 for use in baking a hollow cooked food product such as a bagel is made of a flexible low-friction material which is impervious to boiling and baking temperatures. Such a material is silicone with a durometer hardness measurement of less than 30.

Cooking member 10 is bent into an arcuate, specifically a circular, form 12. Then a predetermined aliquot of bagel dough 14 is molded about the circularly bent cooking member 12 to produce a toroidal dough preform 16 in which the cooking member 12 is embedded. An end portion 18 of cooking member 10 protrudes from preform 16.

Preform 16 including circularly bent cooking member 12 is now ready for cooking by traditional steps of boiling, schematically represented at 20, and baking, schematically represented at 22 in FIG. 1. After the bagel preform has been baked, protruding end portion 18 is contacted and, more particularly, grasped, e.g., by a pliers 24 and pulled from the baked food item 26 to generate a hollow chamber 28.

As further illustrated in FIG. 1, a syringe 30 or other instrument may be subsequently used to inject or otherwise deposit a filling material 32 such as cream cheese or minced meat into chamber 28. An alternative filling instrument (not illustrated) would have an elongate flexible tube which is inserted into chamber 28 and withdrawn as filling material is fed through the tube to an opening at a free end thereof.

It is to be noted that preform 16 may take a form other than toroidal. A food product produced from the preform may be elongate.

The use of a cooking member as described hereinabove may be used to produce hollow food products other than bagels, such as muffins and doughnuts. Also, preform 16 with a straight or bent cooking member 12 may be produced at a first, central, location such as a factory and shipped to remote locations (bakeries) for cooking.

It is generally contemplated that cooking element 10 has a predetermined substantially constant size. However, if a suitable material is available, it would be possible to make the cooking member as an inflatable balloon member. In that event, heating of the balloon and the gases (air) inside it during the cooking process will expand the balloon member further, if only relatively incrementally.

FIG. 2 schematically depicts a machine for automatically forming preform 16. A conveyor belt 34 is provided with a plurality of spaced bottom mold halves 36 each in turn provided with a plurality of vertically oriented pins 38. Pins 38 are slidably attached to the respective bottom mold halves 36 in order to move from a lowered neutral or storage position indicated at 40 to an elevated arrest configuration indicated at 42. Pins 38 are shifted vertically upward from lowered neutral position 40 to elevated arrest configuration 42 owing to a camming action arising from the motion of conveyor belt 34, mold halves 36 and pins 38 along a camming surface 44.

At a first station along a path of movement of belt 34 is disposed a first dough hopper 46. A door 48 provided at a lower end of hopper 46 prevents a deposition of dough onto conveyor belt 34 unless a mold half 36 is located below the hopper. At that time, door 48 is shifted sideways, as indicated by an arrow 48. After a predetermined amount of dough (not shown) has fallen from hopper 46, door 48 is shifted back into the illustrated closure position below the lower end of the hopper. A cutting edge 50 at one end of door 48 severs the predetermined amount of falling dough from the dough remaining in hopper 46.

At a second station along a path of movement of belt 34 is disposed a device 52 for bending cooking member 10 into a generally circular form. An automatically driven flexible rod 54 pushes cooking member 10 through a helical passageway or groove 56 in device 52 until the cooking member rests in a circular configuration on a door 58 at a lower end of device 52. Upon the arrival of a mold half 36 directly below device 52, door 58 is moved laterally to permit a deposition of the bent cooking member onto the dough placed into the mold half at hopper 46. The entire device 52 may be shifted temporarily downwardly to facilitate the proper deposition of the circular cooking member 10 onto the dough and inside a ring of elevated pins 28. Pins 38 serve to maintain cooking member in a curved configuration during the deposition of another predetermined amount of dough 61 from a second hopper 60 over the cooking member 10 and the first amount of dough deposited by hopper 46. Hopper 60 is provided with a reciprocatable door 62 having a cutting edge 64.

At a subsequent station along the path of movement of belt 34, an upper mold half 66 having a cavity 68 is pressed onto the dough deposited by hopper 60 to shape the two aliquots of dough and connect them to one another. To that end, mold half 66 and/or mold half 36 may be provided with vibrators and other devices for ensuring that the two dough portions are intertwined with one another. Concurrently with the above described shaping or molding operation, pins 38 are withdrawn from the combined dough aliquots. This may be accomplished by several methods which will occur to one skilled in the art. A vacuum device (not shown) may ascend and contact the bottom of lower mold half 36 via a rubber seal ring. Application of vacuum will draw pins 38 from the mold. Alternatively, an electromagnet (not shown) may be placed against the bottom of mold half 36 and energized to attach pins 38, which are advantageously made of stainless steel for contact with foodstuffs. The electromagnet may then be lowered, thereby withdrawing the pins.

It is to be noted that the above-described basic assembly line technique may be modified in various ways. For example, hopper 46 may be eliminated, with all of the dough being provided by hopper 60. In that case, a removable lower support is provided for the circularly bent cooking member 10. Such a lower support may comprise a plurality of additional sliding pins. The pins allow the dough to flow around the cooking member during dough deposition and additionally allow the dough to flow together and close up upon the application of molding pressure by upper mold half 66.

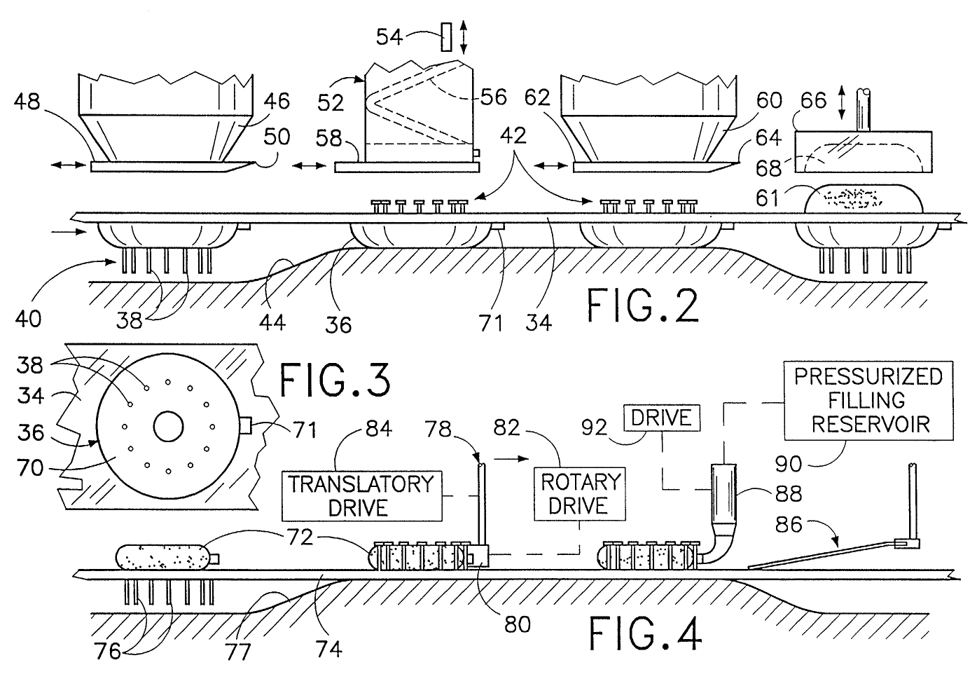

As illustrated in FIG. 3, pins 38 are disposed in a generally circular configuration in a toroidal cavity 70 which is a mirror image of cavity 68 in upper mold half 66. Cavity 70 has an extension 71 for receiving end portion 18 (see FIG. 1) of cooking member 10.

After the formation of preform 16 as described above with reference to FIG. 2, boiling and baking steps are performed as described hereinabove with reference to FIG. 1. These steps may be implemented in accordance with conventional processing techniques.

FIG. 4 shows machine removal of cooking member 10 from a cooked bagel 72. Bagel 72 is deposited on a conveyor belt 74 inside a ring of lowered retaining pins 76. As conveyor 74 moves along its pre-established path of transport, pins 76 are elevated by a camming surface 77 so that the pins substantially surround bagel 72, particularly on a side thereof from which end portion 18 of cooking member protrudes from bagel 72. A grasping device 78 including a chuck or clamp 80 then contacts and grips end portion 18, owing to operation of a rotary drive 82. A translatory drive 84 then moves grasping device 78 away from bagel 72 while the bagel is held by retaining pins 76. The removed cooking member 10 is illustrated at 86. A nozzle 88 connected to a pressurized filling reservoir 90 is then moved into position by a drive 92 and injects comestible filling material inside the hollow bagel 72. Subsequent to the injection or filling operation, the completed filled bagel is mechanically jostled by a jostling mechanism (not illustrated), which may take the form of one or more pneumatic jets, delivering puffs of air. This jostling aids in the disengagement of pins 76 concurrent with recession of camming surface 77 following final processing on belt 74, which disengagement may also be vacuum or magnetically assisted as described above. Pins 38 and 76 will advantageously be given a tapered or conical head shape, to facilitate withdrawal from dough, and minimize damage to the finished product.

It is to be noted that grasping device 78 may approach bagel 72 from a trailing side thereof. In that case, bagel 72 is deposited onto conveyor belt 74 so that end portion 18 points in an upstream direction, i.e., counter to the direction of transport of belt 74. Pins 76 are clustered by the end portion 18, on an upstream or trailing side of bagel 72, for holding the bagel while grasping device 78 engages cooking member 10. The movement of conveyor belt 74 serves to separate bagel 72 and grasping device 78 and remove the cooking member 10.

In an alternative process for producing a hollow comestible product such as a bagel, the function of cooking member 10 is performed by a generally rigid insert made of a dissolvable material. This material should be biologically compatible or edible, such as ice, sugar, frozen gelatin, or salt. Where a hollow bagel is cooked by boiling and baking steps, the insert may be a generally circular piece of ice with a sugar and/or salt content selected to control the rate of dissolution of the insert in the hot water of the boiling step. The salt and/or sugar content will also be selected to vary the flavoring of the eventual food product. For example, the insert might have a core of pure water and an outer layer which has a substantial sugar and/or salt concentration. In that case, the higher sugar and/or salt concentration of the outer layer of the cooking insert delays the disintegration and dissolution of the insert during the initial stages of a boiling procedure. In addition, the salt and/or sugar may be deposited in a greater or lesser concentration on an inner surface of the food product, thereby providing a desirable flavoring.

A dissolvable cooking insert may itself be hollow. During a molding procedure, dough is placed about the cooking insert so as to surround the insert. Mold forms may then close about the dough and the embedded cooking insert, to shaped the dough into a desired form.

In another alternative process for producing a comestible product such as a bagel, the function of cooking member 10 is performed by an insert made of an edible material such as a tuna fish and/or a ham and cream cheese composition. Generally, the food material used for the cooking member or insert should be capable of being hardened, for example, by a freezing process. First the edible insert material is sculpted, molded, or otherwise shaped into the desired form. Then the shaped material is hardened, for example, by a freezing process. Alternatively, a layer of a digestible material, such as sugar or salt or a biocompatible monomer or polymer, may be formed around the basic material and hardened into a shell by a transfer of energy such as heat energy (freezing or convection cooking), electromagnetic energy (infrared radiation), vibrational energy (ultrasonic pressure waves), etc.

After the hardening of the insert or a shell layer thereof, dough is molded about the insert. The entire preform is then subjected to a cooling process. Subsequently, the insert remains in the cooking bagel (or other food product) as a filling. Of course, the cooking of the dough may also cook the material of the insert.

In yet another alternative process for producing a hollow comestible product such as a bagel, the function of cooking member 10 is performed by a plurality of inserts. In the configuration illustrated in FIG. 5, an uncooked toroidal dough mass 142 is formed about a pair of arcuate cross-sectionally circular inserts 140 in such a manner that a pair of cavities are formed in the dough mass of volume and shape substantially equivalent to a cavity formed by single circularly shaped cooking member 12. In this configuration, inserts 140 may evidently be either flexible or rigid, as it is possible to draw the inserts out of a bagel shape without deformation. Following a cooking step occuring either before or after a drawing out of inserts 140 from dough mass 142, a cooked dough mass 142′ results, with a pair of openings 144, 146 for the injection of a filling material into a pair of arcuate chambers 148, 150 of generally circular cross-section.

It is to be noted that the same mechanism for automatically removing a cooking member from a cooked bagel may be used to remove the cooking member from the dough prior to the cooking thereof. The dough is optionally chilled prior to removal of the cooking member to facilitate maintenance of the shape of the dough during and after the removal of the cooking member. In general, a flexible cooking member made of heat impervious material may be removed from an aliquot of dough before or after the cooking process.

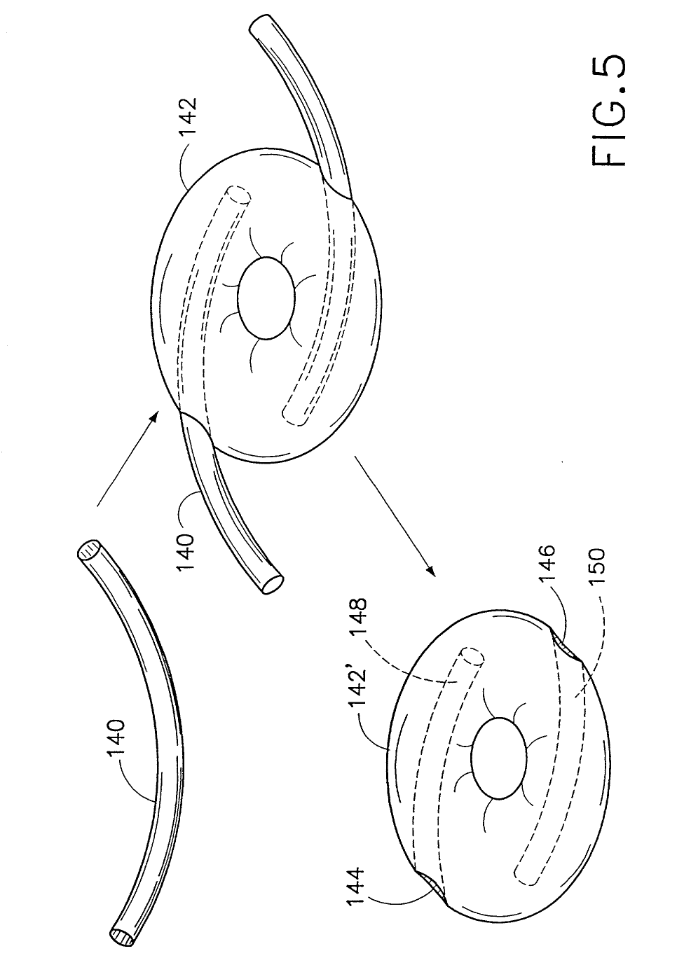

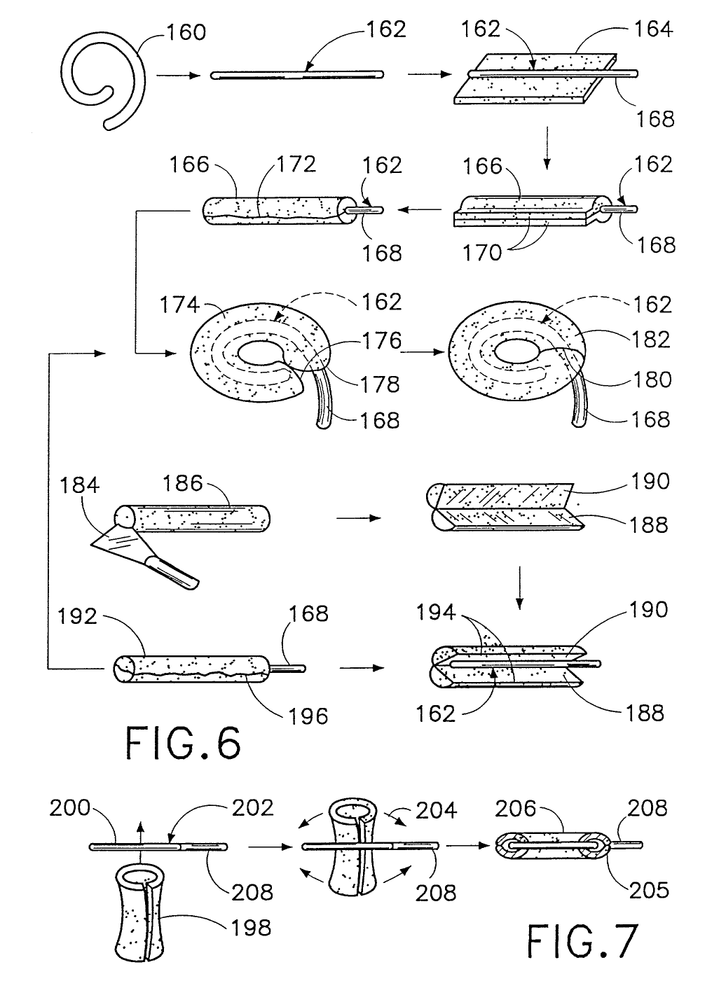

A substantially manual method for producing a preform to be used in producing a hollow comestible product such as a bagel is depicted in FIG. 6. A flexible cooking member 160 has an internal spring bias or “memory,” whereby the cooking member assumes the general shape of a “9” in the absence of imbalanced external forces. An external force (not depicted) is applied to cooking member 160 to stretch the cooking member into a straightened configuration 162 in opposition to the internal spring bias or memory. This external force may be applied by hand or through the assistance of clamps or grippers (not shown) releasably fastened to the ends of the cooking member. Straightened cooking member 162 is placed along a slab of dough 164 which is then folded over the straightened cooking member to form a cylindrical envelope 166, with an end 168 of straightened cooking member 162 projecting free. Juxtaposed longitudinal edges 170 of the folded dough slab are crimped or pinched together to form a dough seam 172 along envelope 166, thereby closing the dough envelope. The external restraining forces on straightened cooking member 162 are then released (if not previously released). Crimped dough envelope 166, together with straightened cooking member 162, is then allowed to assume a substantially circularly curved or annular configuration shown at 174. Force may be applied to dough envelope 166 to urge the dough and the cooking member into the annular configuration 174. Finally, opposite ends 176 and 178 of the annular dough configuration 174 are kneaded and pinched or crimped together to form a joint or seam 180 establishing a continuous bagel shape 182 ready for cooking as described above. The removal of cooking member 160 from the cooked bagel product is effectuated as described above.

In optional alternate steps of a bagel preform manufacturing procedure, a knife 184 or other cutting implement is used to cut a dough blank 186 into halves 188, 190. Straightened cooking member 162 is placed one dough preform half 188. The other preform half 190 is then folded over the straightened cooking member 162 to form a cylindrical envelope 192, again with end 168 of straightened cooking member 162 projecting free. Juxtaposed longitudinal edges 194 of the dough halves 188, 190 are then crimped or pinched together to form a dough seam 196 along reformed dough blank 186, thereby closing the dough blank. The subsequent steps are as described above: the external restraining forces on the straightened cooking member are released, reformed dough blank 186 and the cooking member are allowed or manipulated to assume the substantially circularly curved or annular configuration shown at 174, etc.

It is to be noted that the process described above with reference to FIG. 6 may be truncated for producing a straight or linear dough preform (166, 192) eventually resulting in a straight filled bagel product. This straight or linear dough preform (166, 192), which is subjected to baking and optional boiling procedures to generate a straight or elongate hollow bagel product, takes the form of cylindrical envelope 166 or 192 and is made using a substantially rigid straight cooking member or insert identical to the straightened form 162 of cooking member 160. This modified process yields a cylindrical bagel product with a cylindrical chamber for receiving a comestible filling. Removing the straight cooking member or insert from the cooked food item may be accomplished as discussed hereinafter with reference to FIGS. 41-44. The filling of the chamber may be accomplished using techniques discussed below with reference to FIGS. 21 through 34.

In another alternate procedure, shown in FIG. 7, for forming a dough preform for cooking into a comestible food product, a dough slab 198 is inserted in a substantially cylindrical slotted configuration through an opening (not shown) in a head portion 200 of a 9-shaped resilient cooking member 202. Thereafter, the dough is shaped around head portion 200 of cooking member 202, as indicated by arrows 204. Juxtaposed edges 205 of the folded over dough slab 198 are then kneaded, crimped and/or pinched together to form a closed annular dough preform 206 about cooking member 202, with a tail 208 thereof projecting free of the dough.

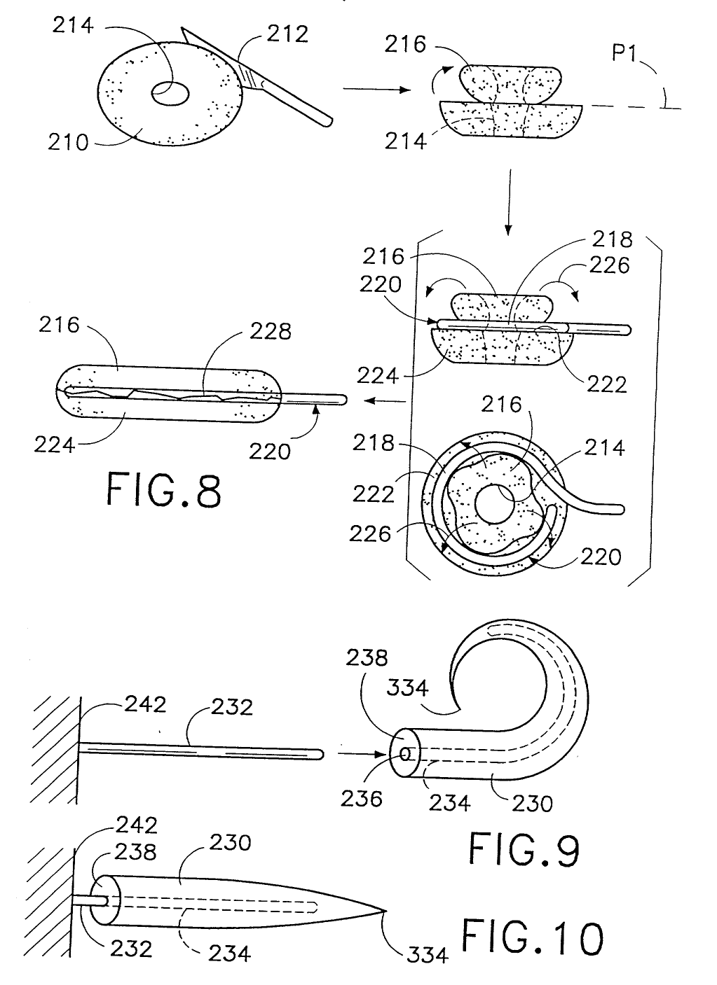

In another alternative method, illustrated in FIG. 8, for forming a dough preform for cooking into a comestible food product, a ring-shaped dough blank 210 is sliced with a knife 212 or other cutting implement along a transverse plane PI. The slicing is preferably partial so that the dough remains uncut along a circular region surrounding a central hole 214. At least one half of the dough 216 is folded away from the other half 224 to enable disposition of a head portion 218 of a figure-9-shaped resilient cooking element 220 between the two halves 216 and 224. Where one half 224 remains intact and undeformed, head portion 218 of cooking element 220 is placed onto a planar face 222, in plane P1, of that dough half 224. Folded dough half 216 is then folded back, over the deposited head portion 218 of cooking element 220, as indicated by arrows 226, to sandwich the head portion inside the dough. A generally circular seam or joint 228 is then kneaded, crimped, and/or pinched to reform dough halves 216 and 224 together.

The two dough halves 216 and 224 may be each bent away from the other to form an annular groove for receiving the head portion 218 of the cooking element. The head portion is temporarily at least partially straightened to permit the winding of the head portion about the deformed dough in the annular groove. Thereafter, the dough of the two halves is folded or kneaded back into place to form an annular or toroidal dough preform.

FIGS. 9 and 10 depict a cooking member 230 and a straightening rod 232 utilizable in performing the method of FIG. 6. Cooking member 230 has an internal spring bias tending to form the cooking member into the shape of a “9” and is provided with a lumen or channel 234 extending from an opening 236 in one end 238. To straighten cooking member 230 prior to the positioning thereof on a piece of dough (162, 188), rod 232 is inserted into lumen or channel 234 via opening 236. As shown in FIG. 10, rod 232 maintains cooking member 230 in a straightened configuration 240 during the formation of a substantially cylindrical dough envelope about the cooking member. After the closure of the dough envelope by kneading, pinching and/or crimping, rod 232 is withdrawn from cooking member 230. Rod 232 may be attached to a stationary or heavy support member 242, facilitating the production of the bagel preform. The rod 234 thus serves to hold the cooking member 230 and the dough during manipulation thereof.

It is to be noted that other devices may be used to maintain a cooking member in a straightened configuration in opposition to internal spring forces tending to shape the cooking member into a “9.” For example, graspers or jaws (not illustrated) mounted to a table top may serve to hold the cooking member after a manual straightening. Or one set of graspers or jaws may be mounted on a track.

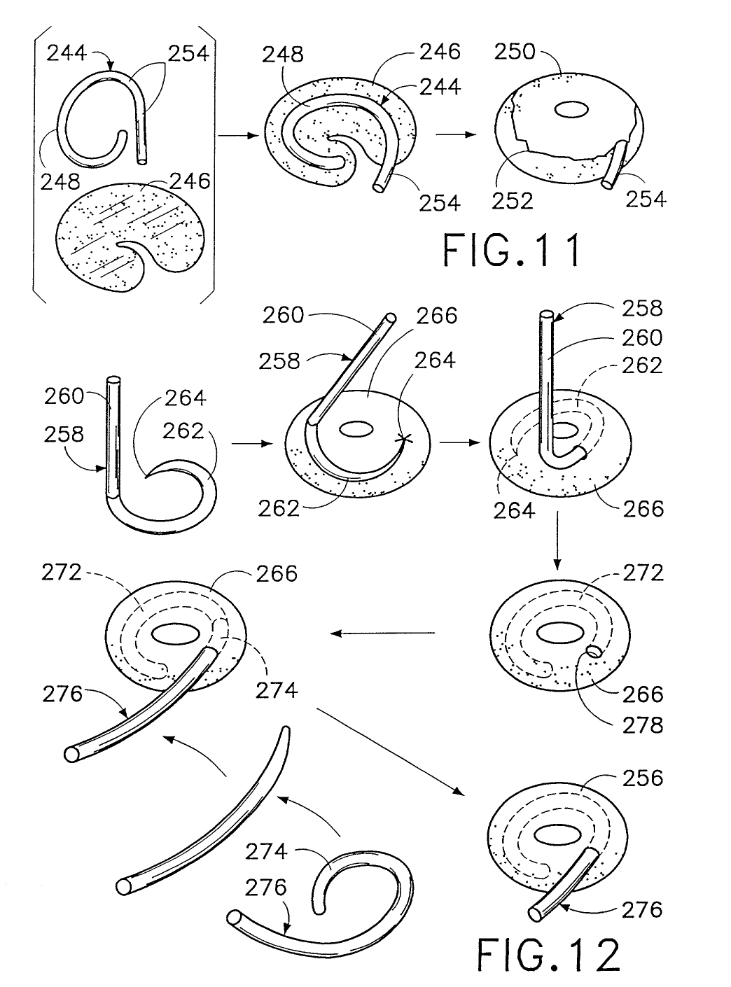

As depicted in FIG. 11, a flexible 9-shaped cooking member 244 is placed on a piece of dough 246 which has been preshaped in a generally circular form. After the placement of a head portion 248 of cooking member 244 onto dough piece 246, the dough is manipulated so that head portion 248 is enclosed in a toroidal dough piece 250 having a sealed seam 252 and so that a tail portion 254 of cooking member 244 protrudes from the dough toroid 250.

FIG. 12 shows a method for producing a cookable bagel preform 256 which entails a coring operation utilizing a coring tool 258. Tool 258 includes a generally straight handle portion 260 and an arcuate end portion 262 terminating in a pointed tip 264. First, pointed tip 264 of tool 258 is inserted into a bagel shaped piece of dough 266. During a further insertion of end portion 262 into dough piece 266, handle portion 260 is twisted to turn end portion 262 along a substantially circular path 268 inside the piece of dough. Upon a completed insertion of end portion 262 along path 268, shown at 270, tool 258 is manipulated to remove end portion 262 from dough piece 266 to form an annular chamber or channel 272. A generally circular head portion 274 of a 9-shaped resilient cooking tool 276 is then inserted into chamber of channel 272 through an opening 278 formed in dough piece 266 by tool 258, thereby forming bagel preform 256.

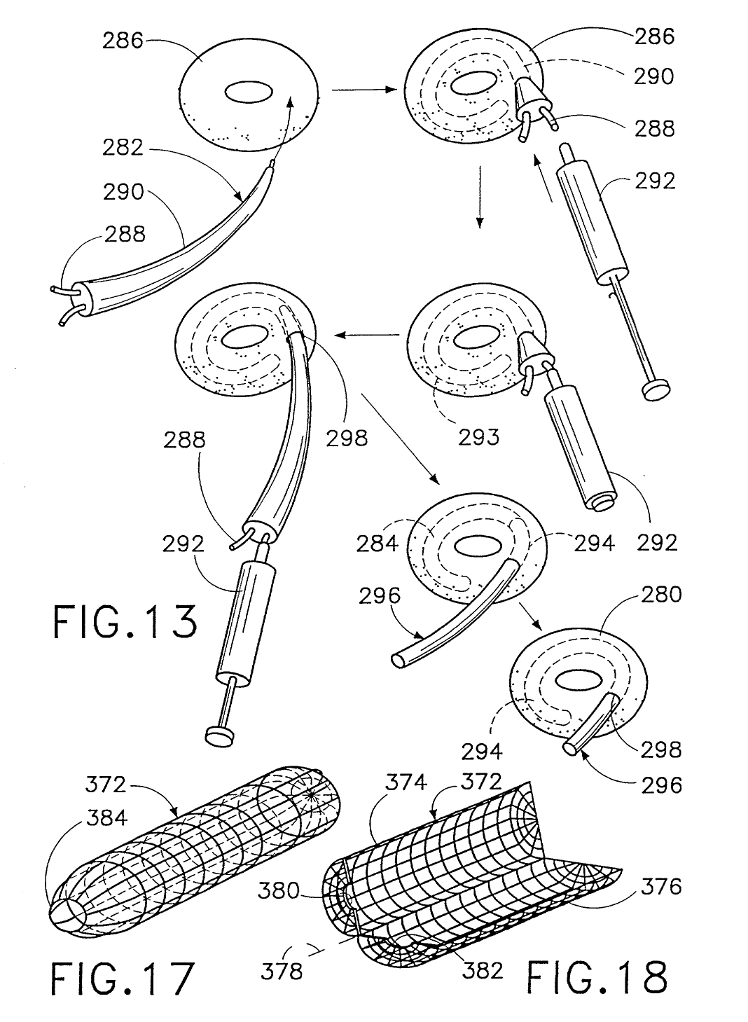

In another method for making a bagel preform 280, shown in FIG. 13, a balloon or bladder instrument 282 is utilized to form a circular chamber or channel 284 in a piece of dough 286. Instrument 282 includes a flexible rod member 288 about which a cylindrical balloon 290 is mounted. A pressure source such as a syringe 292 is removably connectable to balloon 290 to communicate therewith for purposes of inflating the balloon after an enveloping thereof in dough piece 286. Dough 286 is formed about balloon instrument 282 when balloon or bladder 290 is in a deflated condition. Thereafter, syringe 292 is connected to balloon or bladder 290 and use to pressurize the balloon to inflate the same to an expanded configuration 293. Subsequently, balloon 290 is deflated, for example by operating syringe 292 to withdraw air from the balloon. Instrument 282 is then extracted from dough piece 286 to form annular chamber or channel 284. A generally circular head portion 294 of a 9-shaped resilient cooking member 296 is then inserted into chamber of channel 284 through an opening 298, thereby forming bagel preform 280 with a tail portion 300 of cooking member 268 protruding.

An alternative method for forming a bagel preform 302 utilizes a mold 304 having two mold halves 306 and 308 optionally hinged to one another. A slab of dough 310 is placed over the opened mold halves 206 and 308 and then pushed into the mold halves to assume a dual hollowed shape 312. Thereafter, a generally circular head portion 314 of a 9-shaped cooking member 316 is placed onto the dough in one of the mold halves 306 and 308. Mold 304 is then closed so that the shaped dough surrounds circular head portion 314 of cooking member 316. Vibration may be applied to the closed mold to enhance the natural binding effect of the dough. Then, mold 304 is opened at 318 to enable deposition of molded bagel preform 302, with a protruding tail 320 of cooking member 316, onto a conveyor 322 for transport to a cooking apparatus.

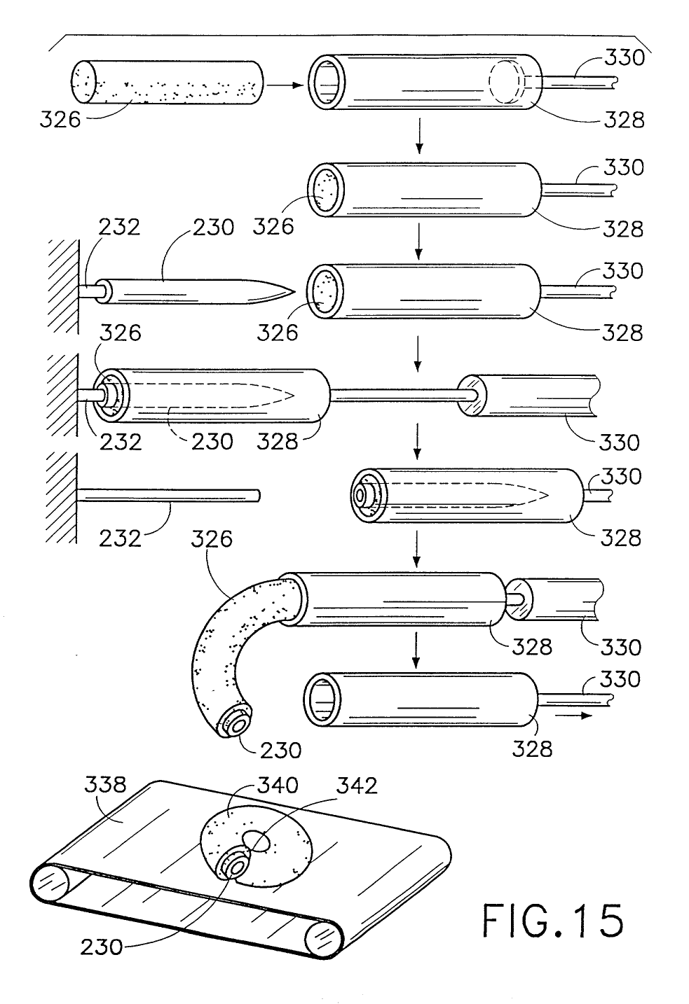

As depicted in FIG. 15, in another method for generating a toroidal bagel preform 324, an elongate cylindrical piece of dough 326 is inserted into a cylindrical holder 328 equipped with a sliding plunger 330. A lubricant such as water or oil may be sprayed or otherwise deposited into holder 328 prior to the insertion of dough piece 326, to facilitate the insertion and removal of the dough piece. Alternatively or additionally, an outer surface (not separately designated) of dough piece 326 may be coated with a lubricant film prior to the insertion of dough piece 326 into cylindrical holder 328. After this insertion step, holder 328 is forced over straightened cooking member 230 (see FIG. 10) so that the cooking member enters dough piece 326, as indicated at 332. It is to be noted that cooking member 332 is advantageously formed with a sharp tip 334 to facilitate penetration of dough piece 326 by the cooking member. After the penetration of the dough piece 326 by cooking member 230, cylindrical holder 328 together with dough piece 326 and cooking member 230 are shifted axially or longitudinally relative to rod 232, thereby extracting the rod from the cooking member, as indicated at 336. At that juncture, plunger 330 is pushed axially through holder 328 to eject dough piece 326 and cooking member 230 from the holder onto a conveyor belt 338 for transport to a boiling vat (not shown) or a baking oven (not shown). Cooking member 230 may have a sufficiently strong internal spring force to automatically curl a portion of itself together with dough piece 326 into a substantially circular configuration 340. Further manipulation, either by machine or by hand is optionally effectuated, prior to cooking, to seal ends 342 of dough piece 326 together to form a continuous circular or annular dough mass. Plunger 330 is withdrawn at 344 to enable a subsequent insertion of another cylindrical or columnar dough blank.

It is to be noted that the process described above with reference to FIG. 15 may be truncated, eliminating the curling of the dough 326 and cooking member 230, to produce a straight or linear dough preform (compare 166, 192 in FIG. 6) eventually resulting in a straight cylindrical filled bagel product. This straight or linear dough preform, which is subjected to baking and optional boiling procedures to generate a straight or elongate hollow bagel product, takes the form of cylindrical envelope and is made using a substantially rigid straight cooking member or insert identical to the straightened form of cooking member 230. This modified process yields a cylindrical bagel product with a cylindrical chamber for receiving a comestible filling. Removing the straight cooking member or insert from the cooked food item may be accomplished as discussed hereinafter with reference to FIGS. 41-44. The filling of the chamber may be accomplished using techniques discussed below with reference to FIGS. 21 through 34. It is to be noted also that the method illustrated in FIG. 15 (absent the curling of the food product into a toroidal form) may be used to simultaneously form a multiplicity of linear dough preforms each provided with a straight cooking member or insert. To produce multiple dough preforms simultaneously simply requires use of a multiplicity of holder rods 232, straight cooking members and cylindrical dough holders 328. The rods 232 may be mounted to a first common frame or bracket, while the cylindrical dough holders 328 are mounted to a second common frame or bracket, the frames being movable relative to one another to effectuate the penetration of the dough in the holders 328 by respective rigid cooking members 230 on rods 232.

As depicted in FIG. 16, a cylindrical dough holder 346 receives a cylindrical dough piece 348. Holder 346 is then manipulated to force a pointed end 350 of a resilient cooking member 352 into dough piece 348. Cooking member 352 has a naturally 9-shaped configuration and is straightened by mounting on a rigid rod 354, substantially as described above with reference to FIGS. 9 and 10. Rod 354 in this case is mounted to a movable pedestal or handle 356. Upon a completed insertion 358 of cooking member 352 and rod 354 into dough piece 348 inside holder 346, holder 346 is removed, as indicated at 360. At that juncture, a tubular ejection member 362 slidably mounted to pedestal or handle 356 and surrounding rod 354 is slid along the rod to eject dough piece 348 and cooking member 352 therefrom onto a conveyor belt 364. As described above with reference to FIG. 15, cooking member 352 may have a sufficiently strong internal spring force to automatically curl a head portion of itself together with dough piece 348 into a substantially circular configuration 366. Further manipulation, either by machine or by hand is optionally effectuated, prior to cooking, to seal ends 368 of dough piece 366 together to form a continuous circular or annular dough mass. Tubular member 362 is retracted as shown at 370 to start another preform production cycle.

The method of FIG. 16 may be executed with a vertical orientation of holder 346 and dough piece 348, as illustrated, or in a horizontal orientation as depicted in FIG. 15. In the vertical orientation, dough piece 248 maintains sufficient friction with the inner surface of holder 346 so that the dough does not slide out prior to insertion of cooking member 352.

The process described above with reference to FIG. 16 may be also be truncated, eliminating the curling of dough piece 348 and cooking member 352, to produce a straight or linear dough preform (compare 166, 192 in FIG. 6) eventually resulting in a straight cylindrical filled bagel product. The remarks made above with respect to modifying the process of FIG. 15 also apply to this modification of the process of FIG. 16.

As illustrated in FIGS. 17 and 18, a cylindrical cage 372 for holding a piece of dough during an insertion of a cooking member such as member 230 (FIGS. 9 and 10) or 352 (FIG. 16) comprises a pair of cage halves 374 and 376 hingedly secured to one another along a pivot line 378. At one end, cage halves 374 and 376 are formed with respective semi-circular cutouts 380 and 382, which are aligned in a closed configuration (FIG. 17) of cage 372 to form a circular opening 384. This opening 384 permits the axial insertion of cooking member 230 in an operation similar to that illustrated in FIG. 15 or FIG. 16. Instead of being subsequently ejected by a plunger, however, the dough piece and the cooking member embedded therein are removed from the cage or holder 372 by opening the cage and turning it upside down to allow the dough and the cooking member to fall out at least partially under the influence of gravity.

FIG. 19 illustrates a similar device 386 for holding a piece of dough during an axial insertion of cooking member 230 or 352. Device 386 comprises two solid semi-cylindrical halves 388 and 390 pivotably joined to one another along a hinge line 392. At one end, halves 388 and 390 are formed with respective semi-circular cutouts 394 and 396, which are aligned in a closed configuration to form a circular opening (not shown). The use of device 386 is similar to the use of cage 372.

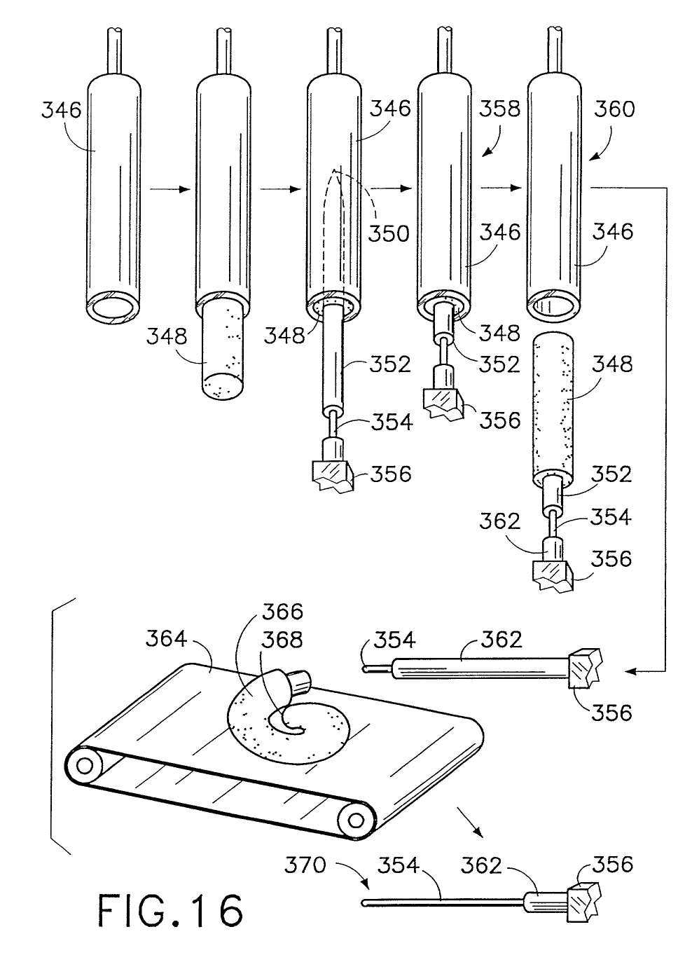

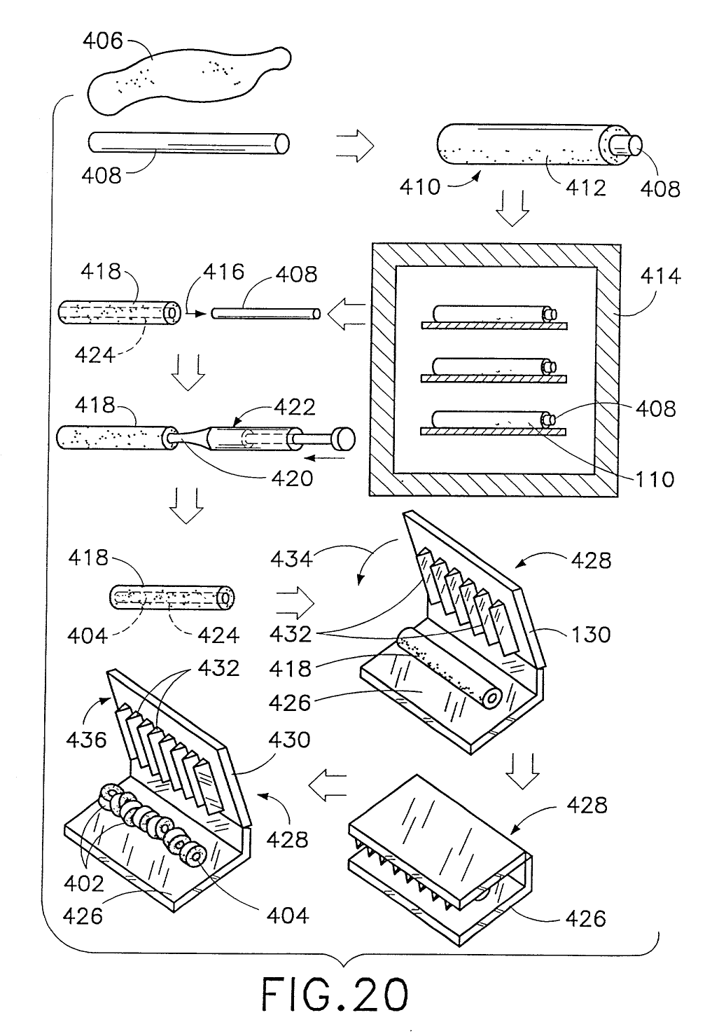

FIG. 20 illustrates successive steps in a method for producing multiple bagel-type food products 402 each having a filling material 404 disposed in a center opening (not separately designated. A predetermined amount of dough 406 is molded or otherwise disposed about an elongate cooking member 408 to form a preform 410. Cooking member 408 is made of a material impervious to cooking temperatures.

Preform 410 comprises dough 406 molded into a cylindrical shape 412 coaxially surrounding cooking member 408. After the formation of preform 410, the preform is placed in a baking oven 414 where the dough 406 of preform is baked. Thereafter, the preform is removed from baking oven 414 and the cooking member 408 is removed, as indicated by an arrow 416, thereby producing a baked farinaceous tubular intermediate product 418. At that juncture, a nozzle 420 of a hydraulic type injector 422 is inserted into a lumen or chamber 424 in intermediate product 418. Injector 422 is actuated to inject comestible food composition or filling 404 into lumen 424. Subsequently, tubular intermediate product 418 with a substantially predetermined quantity of injected food composition 404 is placed on a platen 426 of a slicing device 428 having a pivotally movable flap 430 carrying a plurality of parallel blades 432. Flap 430 is pivoted, as indicated by an arrow 434, to slice tubular intermediate product 418 with the injected food composition 404 in a plurality of spaced planes (not shown). Upon a pivoting of flap 430 back into a rest position, as shown at 436, multiple bagel-type food products 402 each having a filling material 404 disposed in a center opening (not separately designated) are produced.

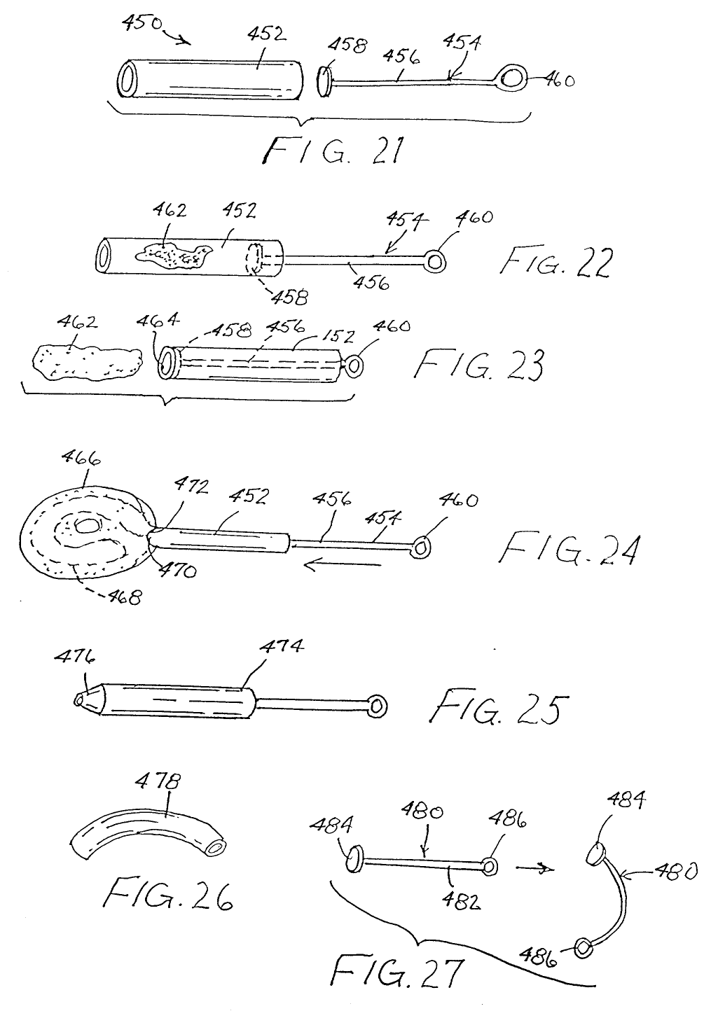

FIG. 21 depicts a filling injection assembly 450 comprising a tubular member 452 and a plunger 454 having an elongate shaft 456 provided at one end with a piston disk 458 and at an opposite end with a ring-shaped handle grip 460. FIG. 22 shows the filling injection assembly 450 of FIG. 21 in an assembled and loaded state. Piston disk 458 is disposed inside tubular member 452 as is a charge of a comestible filling material 462. FIG. 23 shows the piston assembly 450 of FIG. 22 after plunger 454 has been pushed in a distal direction towards an opening or mouth 464 of tubular member 452. The charge of comestible filling material 462 is shown as ejected or discharged from tubular member 452 through opening or mouth 464. FIG. 24 shows the loaded filling injection assembly of FIG. 22 disposed in a filling position relative to a bagel 466 provided with a toroidal chamber 468. Distal tip 470 of tubular member 452 is inserted through a hole 472 in bagel, which hole communicates with chamber 468.

As illustrated in FIG. 25, a tubular filing injection member 474 may be formed at a distal end with a tapered or conical section 476 for facilitating the insertion of that distal end through a hole formed in a bagel as discussed hereinabove. As depicted in FIG. 26, a tubular injection member 478 may be preformed to have an arcuate or curved configuration, whereby the entire tubular member and not just the distal tip thereof may be inserted through a bagel hole into a toroidal bagel chamber. To that end, tubular member 478 is provided with a plunger member 480 (FIG. 27) have a resiliently flexible shaft 482 connected at one end to a piston plate 484 and at an opposite end to a ring-shaped handle grip 486.

In one business method for implementing bagel production, the filling injection assembly 450 of FIG. 21 is shipped to retail bagel stores in a packaged kit 488 as shown in FIG. 28. Multiple tubular members 452 (or 474, 478) and a like number of plungers 454 (or 480) are shipped together in different containers 490 and 492 or a common container 494 as illustrated in FIG. 29. Thus, tubular members 452 and plungers 454 of respective filling injection assemblies 450 may be shipped separately, in a disassembled state (FIG. 28) or, alternatively, connected to one another (FIG. 29).

The present business method contemplates that tubular filling injection members 452, 476 or 478 are shipped either in an empty state or preloaded with respective charges of bagel fillings. In the latter case, each package or container 490 or 494 may contain tubular filling injection members 452 (or 476 or 478) loaded with the same kind or different kinds of filling materials. Of course, where tubular filling injection members 452, 476 or 478 are preloaded with flowable comestible filling materials, it will be necessary in many case to refrigerate the entire packages during shipment.

As shown in FIG. 30, another assembly 496 for injecting filling material into hollowed bagels includes a tubular member 498 and a handle or grip 500. Grip 500 includes a central body section 502 provided at opposite ends with respective planar flanges 504 and 506. Each flange 504 and 506 is in turn provided at a free end, opposite body section 502, with a pair of generally parallel, cylindrically arcuate fingers 508 spaced from one another by a gap 510 for receiving an end or edge portion of tubular member 498. FIGS. 16 and 17 show grip 500 attached to tubular member 498. Opposite ends of tubular member 498 are inserted into gaps 510 between fingers 508. To facilitate assembly of grips 500 to respective tubular members 498, flanges 504 and 506, as well as flanges 508 are made of a resilient material enable distortion of the flanges during an assembly operation.

FIG. 32 shows how the partially assembled filling injection assembly 496 of FIG. 31 is manipulated to load tubular member 498 with a desired filling at a retail establishment or even in the home. Grip 500 is held to enable the user to scoop an aliquot of flowable comestible filling material 512 from a bed (not separately designated) thereof on a container 514. During this procedure for loading tubular member 498 and thus assembly 496, tubular member 498 is angled slightly relative to the bed of filling material 512 and is dragged along the surface of the bed, thereby driving a controllable amount of the filling material into tubular member 498. Before or after the filling of tubular member 498 in this manner, a plunger member (not shown) is partially inserted into one end of the tubular member in anticipation of discharge into a bagel or other hollow food product.

FIGS. 18 and 19 depict a modified filling injection assembly having a tubular member 516 provided in a side wall (not separately designated) with a pair of apertures 518 and 520 for receiving cylindrically arcuate flanges 522 and 524 of a handle or grip 526.

As depicted in FIG. 35, a method for forming a food product (such as a hollow bagel preform) utilizes a support 528 such as a plate provided with a projection 530. Support plate 528 have be disposed on a conveyor (not shown) for moving the plate between successive work stations. At a first work station 532, a first piece of generally flattened dough material 534 is disposed by a laying machine 536 on support plate 528 so that a central region 538 of the dough material 534 is located over projection 530. At a following work station 540, a 9- or 6-shaped cooking insert 542 is placed on dough piece 534 so that a generally circular portion 544 of cooking insert 542 encircles central region 538 of dough piece 534 and encircles projection 530 of support 528 and so that a tail portion 546 of the cooking insert extends beyond a periphery of dough piece 534. Then, a second piece of generally flattened dough material 548 is automatically deposited by a machine 550 over dough piece 534 and at least circular portion 544 of cooking insert 542. Subsequently, a combined cutter and closure device 552 operates to pressed the dough pieces 534 and 548 to one another along an inner circular zone 554 and an outer circular zone 556. Inner circular zone 554 is located inside circular portion 544 of cooking insert 542, while outer circular zone is located outside circular portion 544.

Device 552 includes an inner circular sealing lip 558 and an outer circular sealing lip 560 which cooperate with support plate 528 to mash or knead dough pieces 534 and 548 to one another along circular zones 554 and 556, respectively. Device 552 further includes an inner circular blade 562 and an outer circular blade 566. Inner blade 562 cooperates with support plate 528 and projection 530 to cut circular sections of dough 564 from dough pieces 534 and 548, while outer blade 566 cooperates with support plate 528 to slice dough rings 568 from the peripheries of dough pieces 534 and 548. Device 552 thus acts to form a toroidal dough mass 570 surrounding circular portion 544 of cooking insert 542.

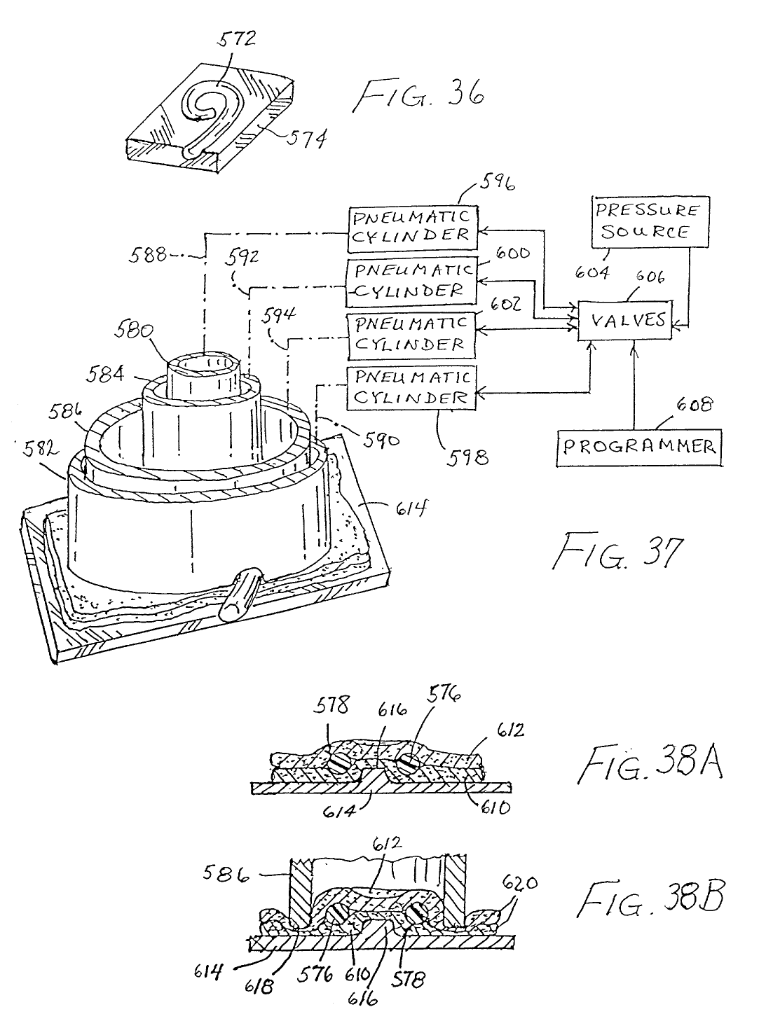

Projection 530 functions at least in part to locate circular portion 544 of cooking insert 542 on dough piece 534. Projection 530 also serves to hold cooking insert 542 in position during subsequent operations, including the deposition of dough piece 548 and the cutting and sealing of dough pieces 534 and 548 by device 552. As illustrated in FIG. 36, the functions of projection 530 may be alternatively performed by a 6- or 9-shaped recess 572 in a support plate 574.

It is to be noted that support 528 and device 552 may embody numerous variations in structure and operation to facilitate the automatic sealing and cutting of dough pieces 534 and 548 along circular zones 554 and 556. Accordingly, the different parts of device 552 (lips 558, 560, blades 562, 566) may be rigidly connected to one another and collectively driven for substantially simultaneous operation. In one modification of this embodiment, the various parts of device 552 may be staggered with respect to one another to cause, for instance, a sealing of dough pieces 534 and 548 to one another along circular zones 554 and 556 prior to the cutting of the dough pieces by blades 562 and 566. Alternatively, as discussed in detail hereinafter with reference to FIGS. 22 et seq., the different parts of device 552 (lips 558, 560, blades 562, 566) may be movably connected to one another and separately driven for sequential operation.

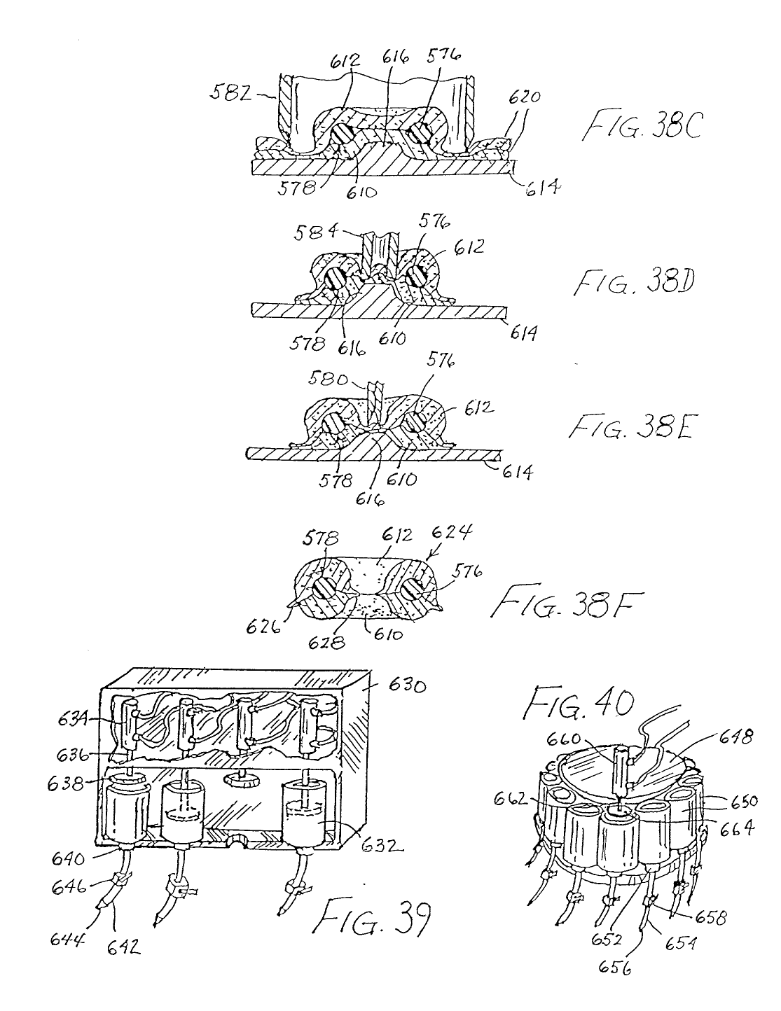

FIG. 37 shows a device for forming doughy bagel preform 624 (see FIG. 38F) surrounding a circular head portion 576 of a cooking insert 578. The device includes a cylindrical inner blade or blade-holding member 580, a cylindrical outer blade or blade-holding member 582, and two cylindrical dough working or pressing members 584 and 586. Each member 580, 582, 584, and 586 is operatively connected by a respective mechanical linkage 588, 590, 592, 594 to a respective pneumatic cylinder 596, 598, 600, 602. Cylinders 596, 598, 600, 602 are selectively coupled to a source 604 of pressurized air and alternately to the atmosphere by a gang of valves 606 in turn operated by a programmer or controller 608.

FIG. 38A shows a pair of substantially flat dough pieces 610 and 612 sandwiching circular head portion 676 of cooking insert 678 and disposed therewith on a support plate 614 so that circular head portion 576 surrounds a generally centrally location projection 616 on plate 614. In a first step of a dough pressing and severing operation, shown in FIG. 38B, annular pressing member 586 is lowered to a position wherein annular regions or peripheries of dough pieces 610 and 612 are squeezed between a lower rim or edge 618 of pressing member 586 and support plate 614. The squeezed or pressed dough of pieces 610 and 612 are thereby worked together to seal the peripheries of the dough pieces to one another. Subsequently, pressing member 586 is raised and outer blade member 582 is lowered, as shown in FIG. 38C, to cut dough pieces 610 and 612 along the pressed or worked regions, on an outer side thereof, thus enabling separation and recycling of excess dough 620. Upon the severing of the excess dough 620 by outer blade member 582, pressing member 584 is then lowered, as shown in FIG. 38D, to press portions of dough pieces 610 and 612 inside circular head portion 576 into connective contact with one another. Thereafter, pressing member 584 is elevated and inner blade member 580 is lowered, as shown in FIG. 38E to sever circular central portions (not designated) of dough pieces 610 and 612. The resulting doughy bagel preform 624 is a w substantially toroidal doughy mass surrounding circular head portion 576 of cooking insert 578. Annular doughy ribs or ridges 626 and 628 may remain in place during subsequent cooking operations. These ribs or ridges 626 and 628, owing to their thinness, become brittle during cooking and are generally broken off during subsequently handling. Alternatively, it is possible to provide further mechanical processing of the bagel preform 624 to knead rims or ridges 626 and 628 into the main dough mass, without separating the toroidally deformed dough pieces 610 and 612.

FIG. 24 illustrates a bagel filling machine comprising a housing or frame 630 holding a plurality of cylindrical containers 632 of generally different comestible filling compositions, such as tuna fish salad, whitefish salad, salmon fish salad, chopped liver salad, various cream cheese or tofu pastes. Each container 632 is associated with a respective pneumatic cylinder 634 having a plunger 636 provided at a lower end with a pressure plate 638. Each pressure plate 638 is placed in contact with a movable lid or upper panel (not shown) of the respective filling container 632 for placing the filling in the container under pressure. Each container 632 is provided at a lower end with an outlet port 640, a hose 642, a nozzle 644, and a manually operable valve 646. a user merely inserts the nozzle 644 of a selected container 632 in a hole of a hollow cooked bagel and manipulates the respective valve 646 to inject the desired filling into the bagel.

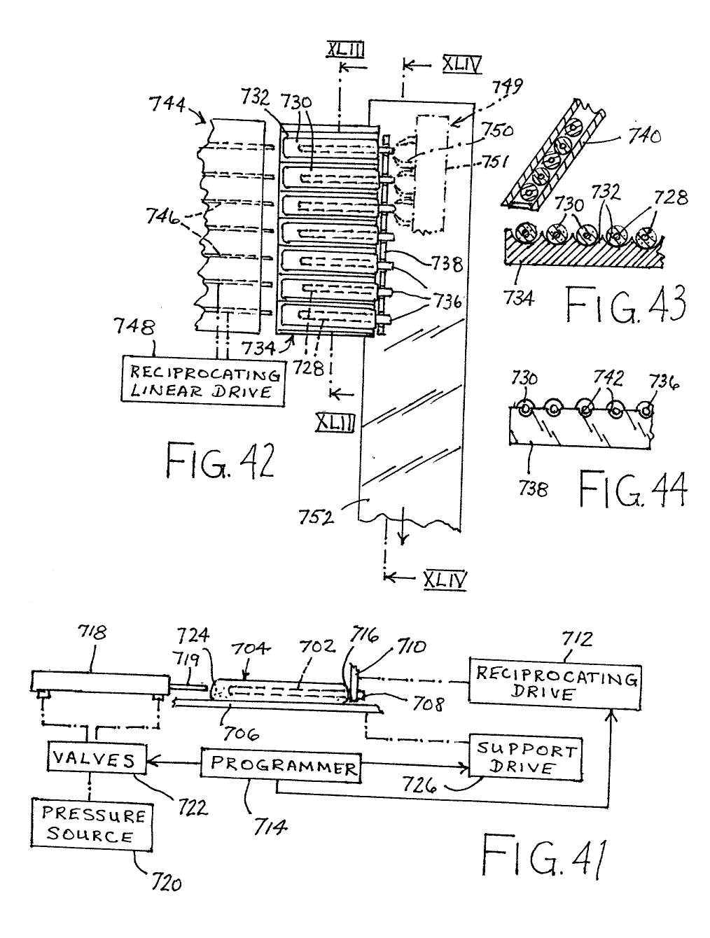

FIG. 40 depicts an alternative bagel filling machine including a rotatable frame, turntable or carousel 648 carrying a multiplicity of cylindrical filling containers 650 in a circular array. Each filling container 650 is provided at a lower end with an outlet port 652, a hose 654, a nozzle 656, and a manually operable valve 658. The machine of FIG. 40 includes a single pneumatic cylinder 660 for alternately pressurizing the different containers 650 brought into registration or alignment with the pneumatic cylinder at a filling station (not designated). Cylinder 660 has a vertically oriented plunger element 662 provided at a lower end with a disk-shaped flange or pressure plate 664. Cylinder 660 is operatively connected to a valve (not shown) and a programmer or controller (not shown) which induces plunger 662 to retract when turntable or carousel is to be rotated to align a different filling container 650 with cylinder 660. Upon alignment, plunger is lowered to place pressure plate 664 into contact with a shiftable upper container panel (not shown) inside the newly aligned container 650. Plunger 662 continues in a downward stroke until the pressure exerted equals a predetermined limit (as detected by a sensor, not shown). Upon registration and pressurization of a selected container 650, a user inserts the nozzle 656 of the selected container in a hole of a hollow cooked bagel and manipulates the respective valve 658 to inject the desired filling into the bagel.

FIG. 41 illustrates apparatus and an associated method for removing a cooking rod 702 from an elongate cooked food product 704 such as a straight bagel. The food product 704 is disposed on a support 706 such as a conveyor belt. An end 708 of cooking rod 702 protrudes from food product 704. On that side of the food product 704, a plate 710 has been lowered by a reciprocating translatory drive 712 under the control of a programmer 714 in the form of a microprocessor. Plate 710 is provided with a cutout (not shown) traversed by end 708 of cooking rod 702, so that the plate may engage an end surface 716 of food product 704. On an opposite side of food product 704 is disposed a pneumatic or hydraulic cylinder 718 (or solenoid) having a plunger rod 719. Cylinder 718 is actuated by a pressurized fluid selectively delivered from a pressure source 720 under the control of valves 722 operated by programmer 714. After the lowering of plate 710 and the positioning of cylinder 718, the cylinder is actuated to shift plunger rod 719 through dough at one end 724 of food product 704 and into contact or engagement with cooking rod 702, to push cooking rod out of the cooked food product. Of course, a contact tool such as a graspers or gripper (see 78, FIG. 4) may be alternatively used to pull the cooking rod 702 out of the cooked food product 704, as discussed above with reference to FIG. 4. After the removal of cooking rod 702, programmer 714 operates valves 722 to remove plunger rod 719 from the food product, reciprocating drive 712 to retract plate 710, and a further drive 726 to move support 706 to transfer the hollow product 704 to a filling station.

FIGS. 42-44 shows apparatus and an associated method for simultaneously removing multiple cooking rods 728 from respective elongate cylindrical cooked food products 730. The food products 730 are disposed in respective cylindrical troughs or grooves 732 on a support 734. The food products may be disposed in the troughs 732 by a deposition device 740 (FIG. 43). The troughs 732 thus automatically locate the food products 730 at pre-established positions. Ends 736 of cooking rods 728 protrude from food products 730. On that side of the food products 730, a plate 738 has been disposed in a raised position by a reciprocating translatory drive (not illustrated) under the control of a microprocessor programmer (not shown). Plate 738 is provided with a plurality of semi-circular cutouts 742 traversed by ends 736 of cooking rods 728, so that the plate may engage end surfaces (not designated) of food products 730. On an opposite side of food product 730 is disposed a rod ejection device 744 including a plurality of reciprocatable rods 746 aligned with the cooking rods 728 of respective food products 730. Rods 746 are reciprocatable by a linear drive 748 under the control of the microprocessor programmer. Alternatively, rods 746 may be actuated by one or more hydraulic or pneumatic cylinders or solenoids, as discussed above with reference to cylinder 718 of FIG. 41. After the lowering of plate 738, rods 746 are shifted into food products 730 and into contact or engagement with the respective cooking rods 728, to thereby push the cooking rods out of the respective cooked food products 730. Of course, a contact tool 749 including multiple graspers or grippers 750 mounted to a frame 751 may be alternatively used to pull the cooking rods 728 out of the cooked food products 730. After the removal of cooking rods 728, rods 746 are retracted out of the food products 730. The now hollow food products 730 may be deposited onto a conveyor belt 752 for conveyance to a filling station (not shown). The depositing of the hollow food products 730 onto conveyor belt 752 may be accomplished by any known method, for instance, by tilting support 734 and allowing the food products to slide out of troughs 732. The troughs may be moistened slightly with a vegetable oil or other biocompatible lubricant to facilitate the sliding of the food products.

A plurality of straight elongate hollow food products 704, 730 from which the cooking rods 702, 728 have been removed may be filled with a flowable comestible material simultaneously. Generally, the multiple hollow food products 704, 730 are disposed on a holder such as support 734 in pre-defined locations. Nozzles (not shown) on a common manifold are then inserted into respective ones of the hollow food products and more particularly into the chambers thereof. The insertion of the nozzles may be accomplished by the relative motion of the support and the manifold. Alternatively, the nozzles may be separately shiftable relatively to the support and the manifold (nozzles connected to the manifold, for example, via hoses).

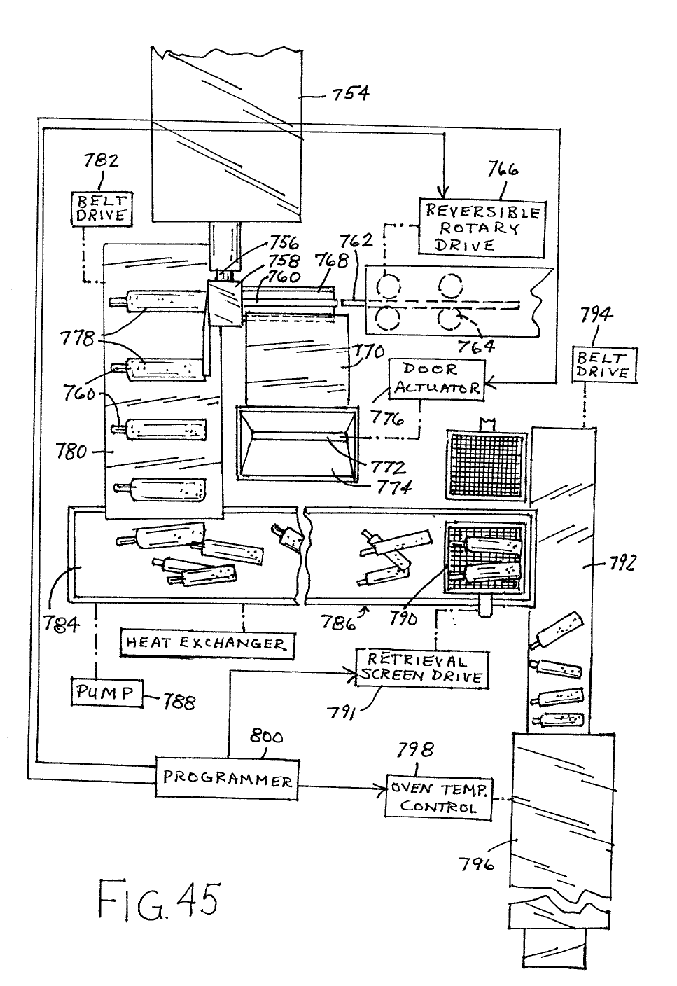

FIG. 45 illustrates a manufacturing assembly for carrying out a continuous (as opposed to a batch) process. An extruder 754 has a nozzle 756 connected to an extrusion die 758 through which an elongate straight cooking rod 760 is shifted by a push rod 762 which is reciprocated by a plurality of rollers 764 powered by a reversible rotary drive 766. Prior to being pushed through extrusion die 758, cooking rod 760 is supported in a grooved plate 768 disposed upstream of the extrusion die. The cooking rod is delivered to grooved plate 768 via an inclined surface 770 extending from an elongate trap door or hatch 772 at a lower end of a hopper 774. Door or hatch 772 is alternatingly opened and closed via a reversible actuator 776.

As further illustrated in FIG. 45, extruded cylindrical dough preforms 778 with respective cooking rods 760 embedded axially in the dough preforms are deposited on a conveyor belt 780 revolved by a drive 782 to transfer the extruded preforms to an upstream end 784 of an elongate tub 786 filled with boiling water. A heat exchanger 786 maintains the water at the boiling temperature, while a pump 788 moves the water from the upstream end 784 towards a pair of retrieval screens 790 which are moved by respective drives 791 (only one shown) to dip into the water in tub 786 and capture one or more boiled dough preforms 778. The retrieval screens 790 operate in tandem to remove the dough preforms 778 and deposit them on a conveyor belt 792 which is moved by a drive 794 to convey the preforms through an oven 796 whose temperature is modulated by a temperature controller or thermostat 798 in turn controlled by a microprocessor programmer 800. Programmer is also connected to reversible rotary drive 766, door actuator 776, and screen drives 791 for coordinating the operations thereof.

Although the invention has been described in terms of particular embodiments and applications, one of ordinary skill in the art, in light of this teaching, can generate additional embodiments and modifications without departing from the spirit of or exceeding the scope of the claimed invention.

For example, other mechanisms are well within the ordinary skill in the art for holding a cooked bagel, on the one hand, and the cooking member 10, on the other hand, and for moving the bagel and the cooking member in opposite directions to extricate the cooking member from the bagel. Also, cooking member 10 may be deposited on an inflated balloon inside a mold cavity. As dough is injected into the mold cavity, the balloon is deflated and withdrawn from the cavity. It is to be understood that the cooking of bagel dough to produce bagels need not include a boiling step, as is frequently the case in contemporary bagel production methods. In addition, a pair of bars may be used for clamping all of the protruding ends (e.g., 736) of the cooking members (e.g., 730) simultaneously. Various drives are operatively connected to the bars for shifting them together towards the bagel products, for clamping the bars and subsequently separating them from one another, and for moving the bars relative to the retaining plate and the held bagels.

Accordingly, it is to be understood that the drawings and descriptions herein are proffered by way of example to facilitate comprehension of the invention and should not be construed to limit the scope thereof.

What is claimed is:

1. A machine for making a food product, comprising:
cooking apparatus for cooking an aliquot of dough having at least one internal chamber formed by disposing said dough in an elongate shape about an elongate straight cooking member made of a material which has a chemical composition essentially impervious to cooking temperatures; and
a mechanism for removing said cooking member from the dough, thereby opening said chamber, said mechanism including:
a contact member disposable in engagement with an end of said cooking member;
a holder disposable in contact with the dough for restraining the cooked dough; and
a motive component operatively connected to at least one of said holder and said contact member for moving said one of said holder and said contact member relative to the other to remove the cooking member from the cooked dough.

2. The machine defined in claim 1 wherein said cooking apparatus includes a baking oven.

3. The machine defined in claim 2 wherein said cooking apparatus includes a molding component for shaping said dough about said cooking member to form said elongate shape about said cooking member.

4. The machine defined in claim 3, wherein said cooking member includes an elongate substantially straight member made of substantially rigid material.

5. The machine defined in claim 4, wherein said machine is configured to position said cooking member in a mold cavity for forming said elongate shape substantially as a cylinder, so that said cooking member is disposed essentially along an axis of said cylinder.

6. The machine defined in claim 1 wherein said cooking apparatus includes a molding component for shaping said dough about said cooking member to form said elongate shape about said cooking member.

7. The machine defined in claim 1, further comprising an injector for depositing an edible filling into said chamber after the pulling of said elongate cooking member from the cooked dough.

8. The machine defined in claim 1 wherein said mechanism includes parts for removing multiple straight cooking members from multiple substantially straight elongate pieces of cooked dough simultaneously to thereby create a chamber in each of the elongate pieces of cooked dough.

9. A method for making a food product, comprising:
cooking an aliquot of dough having an elongate straight internal chamber formed by disposing said dough in an elongate shape about a straight cooking member made of a material which has a chemical composition essentially impervious to cooking temperatures; and
actuating a mechanical contact member to engage an end of said cooking member;
operating a holder mechanism to contact the dough and restrain the dough; and
activating a motive component operatively connected to at least one of said holder and said contact member to move said one of said holder and said contact member relative to the other to remove the cooking member from cooked dough.

10. The method defined in claim 9 wherein the cooking of said dough includes baking said dough.

11. The method defined in claim 10 wherein the cooking of said dough also includes boiling said dough, the boiling of said dough preceding the baking of said dough.

12. The method defined in claim 9, further comprising molding said dough about said cooking member to form said elongate shape about said cooking member prior to the cooking of said dough.

13. The method defined in claim 12 wherein the molding of said dough includes positioning said cooking member in a mold cavity for forming said elongate shape, so that said cooking member is disposed essentially along an axis of said cylinder.

14. The method defined in claim 1, further comprising injecting an edible filling into said chamber after the pulling of said elongate cooking member from the cooked dough.

15. The method defined in claim 1, further comprising removing multiple straight cooking members from multiple substantially straight elongate pieces of cooked dough simultaneously to thereby create an elongate chamber in each of the elongate pieces of cooked dough.

16. A method for making a food product, comprising:
extruding an aliquot of dough in an elongate shape about a straight cooking member or insert;
cooking the extruded dough at a relatively elevated temperature for a predetermined period to form a cooked food product having an internal chamber having essentially said predetermined configuration; and
maintaining said cooking member in said dough during the cooking of said dough.

17. The method defined in claim 16 wherein the cooking member is made of a material which disintegrates at cooking temperatures so that the cooking member essentially disappears by the end of a cooking operation, further comprising gradually disintegrating said cooking member during the cooking of said dough so that, after the cooking of said dough at said elevated temperature for said predetermined period, said cooking member has disappeared from the cooked dough, thereby creating said chamber in the cooked dough.

18. The method defined in claim 17 wherein the cooking member is made of a material dissolvable in water, the disintegrating of said cooking member including dissolving said cooking member.

19. The method defined in claim 16 wherein the cooking member is made of an edible composition, further comprising maintaining said edible composition in said chamber after the cooking of said dough to thereby form a composite food product having a filling surrounded by cooked dough.

20. The method defined in claim 20 wherein the providing of said aliquot of dough disposed in said predetermined shape about said cooking member or insert further includes hardening the shaped edible composition of said cooking member prior to molding of said dough about said cooking member.

21. The method defined in claim 20 wherein the hardening of said shaped edible composition includes lowering the temperature of said shaped edible composition.

22. A method for preparing food, comprising:
forming dough about a plurality of elongate straight cooking members to form a plurality of substantially straight elongate dough preforms;
baking said dough preforms simultaneously while maintaining said elongate straight cooking members therein;
after cooking of said dough preforms, removing said cooking members from the respective cooked dough preforms, thereby producing a plurality of elongate straight cooked dough forms having elongate straight chambers; and
after the removing of said cooking members, automatically injecting edible filling material into the chambers of the cooked dough forms.

23. The method defined in claim 22 wherein the forming of the dough about said cooking members includes operating a machine to simultaneously form the dough about said cooking members.

24. The method defined in claim 23 wherein the removing of said cooking members includes operating another machine to remove said cooking members from the respective cooked dough preforms.

25. The method defined in claim 24 wherein the removing of said cooking members is effectuated substantially simultaneously.

26. The method defined in claim 22 wherein the injecting of the edible filling includes simultaneously injecting the edible filling into said chambers.
